(19) United States
(12) Patent Application Publication
(10) Pub. No.: US 2025/0351170 A1
(43) Pub. Date: Nov. 13, 2025

(54) SIGNALING FRAMEWORK FOR UNASSOCIATED ACCESS POINT COORDINATION

(71) Applicant: QUALCOMM Incorporated, San Diego, CA (US)

(72) Inventors: Abhishek Pramod PATIL, San Diego, CA (US); Sanket Sanjay KALAMKAR, San Diego, CA (US); Gaurang NAIK, San Diego, CA (US); Alfred ASTERJADHI, San Diego, CA (US); George CHERIAN, San Diego, CA (US); Sai Yiu Duncan HO, San Diego, CA (US); Sherief HELWA, San Diego, CA (US); Giovanni CHISCI, San Diego, CA (US)

(21) Appl. No.: 18/657,758

(22) Filed: May 7, 2024

(51) Int. Cl. H04W 74/0816; H04L 5/00; H04W 74/08

(52) U.S. Cl. CPC H04W 74/0816; H04L 5/0053; H04W 74/0866

(57) ABSTRACT

This disclosure provides methods, components, devices and systems for a signaling framework for unassociated access point (AP) coordination. Some aspects more specifically relate to unassociated AP coordination with respect to transmission opportunity (TXOP) sharing (TXS). In some examples, a first AP may obtain a TXOP via performing a contention resolution procedure and may transmit an indication of a portion of the TXOP to share as well as an indication of wireless medium coordination information to a second AP that is in an unassociated state with respect to the first AP. The first AP may receive one or more frames from the second AP based at least in part on the wireless medium coordination information. The second AP also may transmit one or more frames to one or more other APs, where the one or more frames may indicate a TXOP return indication according to the wireless medium coordination information.

### TECHNICAL FIELD

This disclosure relates generally to wireless communication and, more specifically, to a signaling framework for unassociated access point coordination.

### DESCRIPTION OF THE RELATED TECHNOLOGY

Wireless communication networks may include various types of wireless communication devices including network entities (such as wireless access points (AP) or base stations (BS)), client devices (such as wireless stations (STAs) or user equipment (UEs)), and other wireless nodes. These wireless communication devices may communicate with one another via a variety of technologies and wireless communication protocols, including wireless local area network (WLAN) or Wi-Fi-based protocols or cellular (such as 4G, 5G, or 6G)-based protocols. The wireless communication networks may be capable of supporting communication with multiple users by sharing the available system resources (such as time, frequency, and spatial resources). To enable features or provide improved performance, the wireless communication devices may employ technologies such as orthogonal frequency divisional multiple access (OFDMA), multi-user Multiple-Input Multiple-Output (MU-MIMO), spatial multiplexing, and beamforming. For greater inter-operability, the wireless communication networks may support backwards compatibility (such as supporting legacy wireless communication devices) as well as forward compatibility (such as supporting communication with wireless communication devices compatible with next-generation wireless communication standards).

### SUMMARY

The systems, methods, and devices of this disclosure each have several innovative aspects, no single one of which is solely responsible for the desirable attributes disclosed herein.

One innovative aspect of the subject matter described in the disclosure can be implemented in a method for wireless communication performable by or at a first wireless access point (AP). The method may include receiving, from a second AP, one or more first frames that indicate wireless medium coordination information associated with a transmission opportunity (TXOP) of a shared wireless medium obtained by the second AP, the one or more first frames indicating an allocation of a portion of the TXOP to the first AP, where the first AP and the second AP are in an unassociated state with respect to each other and communicating, in accordance with the wireless medium coordination information, one or more second frames with one or more wireless devices or one or more APs via the portion of the TXOP.

One innovative aspect of the subject matter described in this disclosure can be implemented in a first wireless AP for wireless communications. The first wireless AP may include a processing system that includes processor circuitry and memory circuitry that stores code. The processing system may be configured to cause the first wireless AP to receive, from a second AP, one or more first frames that indicate wireless medium coordination information associated with a TXOP of a shared wireless medium obtained by the second AP, the one or more first frames indicating an allocation of a portion of the TXOP to the first AP, where the first AP and the second AP are in an unassociated state with respect to each other and communicate, in accordance with the wireless medium coordination information, one or more second frames with one or more wireless devices or one or more APs via the portion of the TXOP.

Another innovative aspect of the subject matter described in this disclosure can be implemented in another first wireless AP for wireless communications. The first wireless AP may include means for receiving, from a second AP, one or more first frames that indicate wireless medium coordination information associated with a TXOP of a shared wireless medium obtained by the second AP, the one or more first frames indicating an allocation of a portion of the TXOP to the first AP, where the first AP and the second AP are in an unassociated state with respect to each other and means for communicating, in accordance with the wireless medium coordination information, one or more second frames with one or more wireless devices or one or more APs via the portion of the TXOP.

Another innovative aspect of the subject matter described in this disclosure can be implemented in a non-transitory computer-readable medium storing code for wireless communications. The code may include instructions executable by one or more processors to receive, from a second AP, one or more first frames that indicate wireless medium coordination information associated with a TXOP of a shared wireless medium obtained by the second AP, the one or more first frames indicating an allocation of a portion of the TXOP to the first AP, where the first AP and the second AP are in an unassociated state with respect to each other and communicate, in accordance with the wireless medium coordination information, one or more second frames with one or more wireless devices or one or more APs via the portion of the TXOP.

In some examples of the method, first APs, and non-transitory computer-readable medium described herein, the one or more APs include the second AP and the one or more second frames include a TXOP return indication within a header of the one or more second frames, a body of the one or more second frames, or both, in accordance with the wireless medium coordination information.

In some examples of the method, first APs, and non-transitory computer-readable medium described herein, the TXOP return indication may be within a field of a header of the one or more second frames.

In some examples of the method, first APs, and non-transitory computer-readable medium described herein, the one or more second frames indicate that a remainder of the TXOP may be being returned.

In some examples of the method, first APs, and non-transitory computer-readable medium described herein, communicating the one or more second frames may include operations, features, means, or instructions for transmitting, to the second AP, one or more of a clear to send indication, a block acknowledgement frame, a block acknowledgment request frame, or any combination thereof, to indicate a TXOP return indication to indicate that a remainder of the TXOP may be being returned.

In some examples of the method, first APs, and non-transitory computer-readable medium described herein, the one or more second frames include a management frame or a control frame.

In some examples of the method, first APs, and non-transitory computer-readable medium described herein, the one or more second frames include the management frame and the management frame may be a public action frame or an action frame.

In some examples of the method, first APs, and non-transitory computer-readable medium described herein, the one or more second frames include the management frame and the management frame does not include a frame body field.

Some examples of the method, first APs, and non-transitory computer-readable medium described herein may further include operations, features, means, or instructions for receiving, from the second AP, one or more third frames that include feedback that indicates whether the one or more second frames were successfully received at the second AP.

In some examples of the method, first APs, and non-transitory computer-readable medium described herein, communicating the one or more second frames may include operations, features, means, or instructions for transmitting, to the second AP, a frame indicating one or more subchannels of the portion of the TXOP over which the first AP communicated the one or more second frames.

In some examples of the method, first APs, and non-transitory computer-readable medium described herein, receiving the one or more first frames may include operations, features, means, or instructions for receiving a list that indicates a set of multiple APs and an order of the set of multiple APs for sharing of one or more portions of the TXOP in accordance with the order.

In some examples of the method, first APs, and non-transitory computer-readable medium described herein, communicating the one or more second frames may include operations, features, means, or instructions for transmitting, to a third AP, an indication of a second allocation of a second portion of the TXOP to the third AP in accordance with the order.

In some examples of the method, first APs, and non-transitory computer-readable medium described herein, communicating the one or more second frames may include operations, features, means, or instructions for transmitting, to the third AP, security information associated with the TXOP, the second portion of the TXOP, or both.

Some examples of the method, first APs, and non-transitory computer-readable medium described herein may further include operations, features, means, or instructions for receiving an indication of a capability, an operational mode, or both, of the second AP, third AP, or both, to allow sharing of the TXOP, where transmitting the indication of the second allocation to the third AP may be associated with the capability, the operational mode, or both, of the second AP, the third AP, or both.

In some examples of the method, first APs, and non-transitory computer-readable medium described herein, the wireless medium coordination information includes an indication of a buffer status, a TXOP parameter, an intention to not participate in response to receiving a polling frame, one or more APs that may be disallowed from participating in the TXOP, one or more spatial reuse candidate AP pairs, a coordinated beam forming request, a starting or stopping procedure for a second TXOP associated with a third AP, one or more network allocation vector (NAV) protection settings, a dynamic bandwidth expansion indication, a coordinated target wake up time, or any combination thereof.

Some examples of the method, first APs, and non-transitory computer-readable medium described herein may further include operations, features, means, or instructions for setting an address field of the one or more second frames to a special address for communicating coordination information between unassociated APs.

In some examples of the method, first APs, and non-transitory computer-readable medium described herein, the unassociated state includes an unauthenticated state and the first AP and the second AP may be in the unassociated state based on failure to exchange one or more association frames, failure to exchange one or more reassociation frames, failure to establish a security key, or any combination thereof.

In some examples of the method, first APs, and non-transitory computer-readable medium described herein, the first AP and the second AP may be in the unassociated state with respect to each other based on the first AP failing to request to join a basic service set associated with the second AP.

A method for wireless communications by a second wireless AP is described. The method may include performing a contention procedure to obtain a TXOP of a shared wireless medium, transmitting, to a first AP, one or more first frames that indicate wireless medium coordination information associated with the TXOP of the shared wireless medium obtained by the second AP, the one or more first frames indicating an allocation of a portion of the TXOP to the first AP, where the first AP and the second AP are in an unassociated state with respect to each other, and receiving one or more second frames from the first AP in accordance with the wireless medium coordination information.

A second wireless AP for wireless communications is described. The second wireless AP may include a processing system that includes processor circuitry and memory circuitry that stores code. The processing system may be configured to cause the second wireless AP to perform a contention procedure to obtain a TXOP of a shared wireless medium, transmit, to a first AP, one or more first frames that indicate wireless medium coordination information associated with the TXOP of the shared wireless medium obtained by the second AP, the one or more first frames indicating an allocation of a portion of the TXOP to the first AP, where the first AP and the second AP are in an unassociated state with respect to each other, and receive one or more second frames from the first AP in accordance with the wireless medium coordination information.

Another second wireless AP for wireless communications is described. The second wireless AP may include means for performing a contention procedure to obtain a TXOP of a shared wireless medium, means for transmitting, to a first AP, one or more first frames that indicate wireless medium coordination information associated with the TXOP of the shared wireless medium obtained by the second AP, the one or more first frames indicating an allocation of a portion of the TXOP to the first AP, where the first AP and the second AP are in an unassociated state with respect to each other, and means for receiving one or more second frames from the first AP in accordance with the wireless medium coordination information.

A non-transitory computer-readable medium storing code for wireless communications is described. The code may include instructions executable by one or more processors to perform a contention procedure to obtain a TXOP of a shared wireless medium, transmit, to a first AP, one or more first frames that indicate wireless medium coordination information associated with the TXOP of the shared wireless medium obtained by the second AP, the one or more first frames indicating an allocation of a portion of the TXOP to the first AP, where the first AP and the second AP are in an unassociated state with respect to each other, and receive one or more second frames from the first AP in accordance with the wireless medium coordination information.

In some examples of the method, second APs, and non-transitory computer-readable medium described herein, the one or more second frames include a TXOP return indication in accordance with the wireless medium coordination information and the TXOP return indication indicates that a remainder of the TXOP may be being returned.

In some examples of the method, second APs, and non-transitory computer-readable medium described herein, the TXOP return indication may be within a field of a header of the one or more second frames.

In some examples of the method, second APs, and non-transitory computer-readable medium described herein, the one or more second frames indicate that a remainder of the TXOP may be being returned.

In some examples of the method, second APs, and non-transitory computer-readable medium described herein, receiving the one or more second frames may include operations, features, means, or instructions for receiving, from the first AP, one or more of a clear to send indication, a block acknowledgement frame, a block acknowledgment request frame, or any combination thereof, to indicate a TXOP return indication to indicate that a remainder of the TXOP may be being returned.

In some examples of the method, second APs, and non-transitory computer-readable medium described herein, the one or more second frames include a management frame or a control frame.

In some examples of the method, second APs, and non-transitory computer-readable medium described herein, the one or more second frames include the management frame and the management frame may be a public action frame or an action frame.

In some examples of the method, second APs, and non-transitory computer-readable medium described herein, the one or more second frames include the management frame and the management frame does not include a frame body field.

Some examples of the method, second APs, and non-transitory computer-readable medium described herein may further include operations, features, means, or instructions for transmitting, to the first AP, one or more third frames that include feedback that indicates whether the one or more second frames were successfully received at the second AP.

In some examples of the method, second APs, and non-transitory computer-readable medium described herein, receiving the one or more second frames may include operations, features, means, or instructions for receiving, from the first AP, a frame indicating one or more subchannels of the portion of the TXOP over which the first AP communicated one or more third frames.

In some examples of the method, second APs, and non-transitory computer-readable medium described herein, transmitting the one or more first frames may include operations, features, means, or instructions for transmitting a list that indicates a set of multiple APs and an order of the set of multiple APs for sharing of one or more portions of the TXOP in accordance with the order.

Some examples of the method, second APs, and non-transitory computer-readable medium described herein may further include operations, features, means, or instructions for transmitting, to the first AP, an indication of a capability, an operational mode, or both, of the second AP to allow sharing of the TXOP.

In some examples of the method, second APs, and non-transitory computer-readable medium described herein, the wireless medium coordination information includes an indication of a buffer status, a TXOP parameter, an intention to not participate in response to receiving a polling frame, one or more APs that may be disallowed from participating in the TXOP, one or more spatial reuse candidate AP pairs, a coordinated beam forming request, a starting or stopping procedure for a second TXOP associated with an AP, one or more NAV protection settings, a dynamic bandwidth expansion indication, a coordinated target wake up time, or any combination thereof.

In some examples of the method, second APs, and non-transitory computer-readable medium described herein, an address field of the one or more second frames may be set to a special address for communicating coordination information between unassociated APs.

In some examples of the method, second APs, and non-transitory computer-readable medium described herein, the unassociated state includes an unauthenticated state and the first AP and the second AP may be in the unassociated state based on failure to exchange one or more association frames, failure to exchange one or more reassociation frames, failure to establish a security key, or any combination thereof.

In some examples of the method, second APs, and non-transitory computer-readable medium described herein, the first AP and the second AP may be in the unassociated state with respect to each other based on the first AP failing to request to join a basic service set associated with the second AP.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication network.

FIG. 2 shows an example protocol data unit (PDU) usable for communications between a wireless access point (AP) and one or more wireless stations (STAs).

FIG. 3 shows an example of a process flow that supports a signaling framework for unassociated AP coordination.

FIG. 4 shows an example of a block acknowledgment frame format that supports a signaling framework for unassociated access port coordination.

FIG. 5 shows a block diagram of an example wireless communication device that supports a signaling framework for unassociated AP coordination.

FIG. 6 shows a flowchart illustrating an example process performable by or at a first AP that supports a signaling framework for unassociated AP coordination.

FIG. 7 shows a flowchart illustrating an example process performable by or at a second AP that supports a signaling framework for unassociated AP coordination.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G, 5G (New Radio (NR)) or 6G standards promulgated by the 3rd Generation Partnership Project (3GPP), among others.

The described examples can be implemented in any suitable device, component, system or network that is capable of transmitting and receiving RF signals according to one or more of the following technologies or techniques: code division multiple access (CDMA), time division multiple access (TDMA), orthogonal frequency division multiplexing (OFDM), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO (MU-MIMO). The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), a non-terrestrial network (NTN), or an internet of things (IoT) network.

In some wireless communication networks, one or more wireless access points (APs) may exchange one or more frames according to a coordinated time division multiple access (C-TDMA) frame exchange sequence. For example, a first AP may obtain access to a transmission opportunity (TXOP) (such as a set of resources for communicating frames), and may transmit one or more schedule announcement frames which may identify a second AP with whom the first AP may share a portion of the TXOP. Additionally, or alternatively, the one or more scheduling announcement frames may indicate a starting time (such as estimated starting time) and a duration (such as an estimated duration) of the shared portion of the TXOP. The first AP also may transmit a TXOP allocation frame, which may allocate the portion of the TXOP to the second AP (such as to cause the second AP to begin using the portion of the TXOP). In some examples, the shared portion of the TXOP may end prior to an ending of the TXOP, creating a remaining portion of the TXOP that is after the shared portion of the TXOP. However, the first AP and the second AP may be in an unassociated state (such as not having exchanges of associating signaling, exchanges of reassociation signaling, or established a security key), which may limit signaling between the first AP and the second AP to coordinate a use of the remaining portion of the TXOP. The unassociated state may be an unauthorized state. For example, the second AP may signal that the second AP is finished using the shared portion of the TXOP via a contention free end (CF-End) frame, however this may alert one or more other devices (such as APs/wireless stations) which may attempt to utilize the TXOP, resulting in wireless signal collisions and less efficient use of the TXOP. In such a case, and in others scenarios described herein, a method of coordination between unassociated APs may be beneficial.

Various aspects relate generally to methods for coordination between unassociated APs. Some aspects more specifically relate to methods for coordination between unassociated APs in the context of medium access for a TXOP (such as TXOP sharing (TXS)), or for one or more other scenarios described herein. In some examples, a first AP may obtain access to a TXOP via performing a contention resolution procedure. The first AP may transmit an indication of a portion of the TXOP to share as well as an indication of wireless medium coordination information to a second AP (where the first AP and the second AP may be in an unassociated state with respect to each other). The first AP may receive one or more frames from the second AP based at least in part on the wireless medium coordination information. Alternatively, or additionally, the second AP may transmit the one or more frames to one or more APs or one or more wireless devices (such as one or more wireless stations (STAs)). In some examples, the one or more frames may indicate a TXOP return indication according to the wireless medium coordination information, which may indicate that the second AP is returning an unused portion of the TXOP (such as back to the first AP, to another AP). In some examples, the one or more frames may include a management frame, a public action frame, a null management frame, a block acknowledgment frame, a block acknowledgment request frame, or one or more other frames (such as described herein). Thus, the techniques described herein may allow a plurality of APs (such as including the first AP and the second AP) to coordinate medium access while in the unassociated state.

Particular aspects of the subject matter described in this disclosure can be implemented to realize one or more of the following potential advantages. In some examples, by allowing one or more APs to coordinate medium access while in an unassociated state, the described techniques can be used to improve wireless medium (such as wireless resource) utilization in a wireless communications system. For example, the described techniques may provide for an AP to indicate a TXOP return to a specified AP via one or more frames or frameworks, which may allow for a more organized and efficient approach of allocating wireless medium. Further, by providing a framework for coordination between unassociated APs, the described techniques may allow for more efficient use of wireless medium in multiple scenarios.

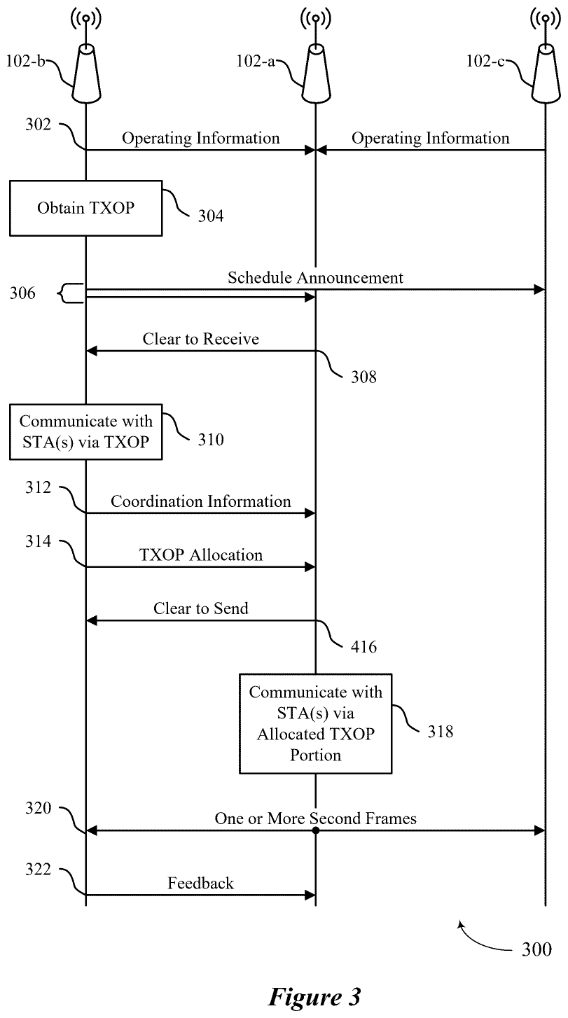

Although the present disclosure may describe techniques for unassociated AP coordination with reference to TXS and a TXOP return indication, the techniques may be applied in any scenario for communication of coordination information between unassociated APs (such as described herein with respect to FIG. 3).

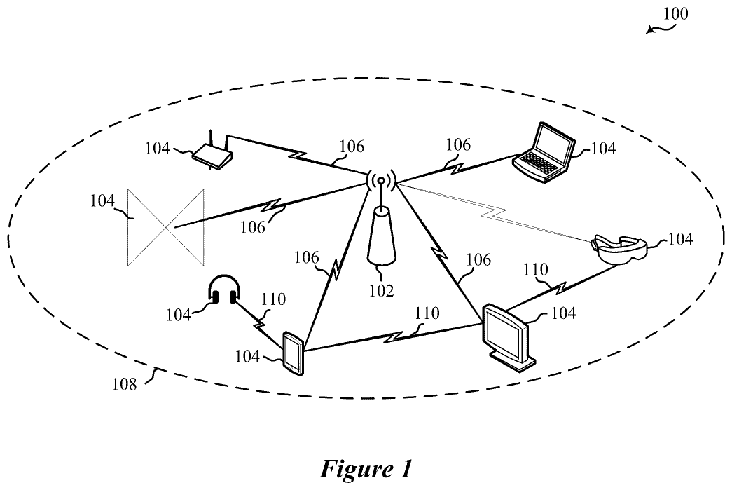

FIG. 1 shows a pictorial diagram of an example wireless communication network 100. According to some aspects, the wireless communication network 100 can be an example of a wireless local area network (WLAN) such as a Wi-Fi network. For example, the wireless communication network 100 can be a network implementing at least one of the IEEE 802.11 family of wireless communication protocol standards, such as defined by the IEEE 802.11-2020 specification or amendments thereof (including, but not limited to, 802.11ay, 802.11ax (also referred to as Wi-Fi 6), 802.11az, 802.11ba, 802.11bc, 802.11bd, 802.11be (also referred to as Wi-Fi 7), 802.11bf, and 802.11bn (also referred to as Wi-Fi 8)) or other WLAN or Wi-Fi standards, such as that associated with the Integrated Millimeter Wave (IMMW) study group. In some other examples, the wireless communication network 100 can be an example of a cellular radio access network (RAN), such as a 5G or 6G RAN that implements one or more cellular protocols such as those specified in one or more 3GPP standards. In some other examples, the wireless communication network 100 can include a WLAN that functions in an interoperable or converged manner with one or more cellular RANs to provide greater or enhanced network coverage to wireless communication devices within the wireless communication network 100 or to enable such devices to connect to a cellular network's core, such as to access the network management capabilities and functionality offered by the cellular network core. In some other examples, the wireless communication network 100 can include a WLAN that functions in an interoperable or converged manner with one or more personal area networks, such as a network implementing Bluetooth or other wireless technologies, to provide greater or enhanced network coverage or to provide or enable other capabilities, functionality, applications or services.

The wireless communication network 100 may include numerous wireless communication devices including an AP 102 and any number of wireless stations (STAs) 104. While only one AP 102 is shown in FIG. 1, the wireless communication network 100 can include multiple APs 102 (such as in an extended service set (ESS) deployment, enterprise network or AP mesh network), or may not include any AP at all (such as in an independent basic service set (IBSS) such as a peer-to-peer (P2P) network or other ad hoc network). The AP 102 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP multi-link device (MLD)), as well as cellular (such as 3GPP, 4G LTE, 5G or 6G) base stations or other cellular network nodes such as a Node B, an evolved Node B (eNB), a gNB, a transmission reception point (TRP) or another type of device or equipment included in a radio access network (RAN), including Open-RAN (O-RAN) network entities, such as a central unit (CU), a distributed unit (DU) or a radio unit (RU).

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, other handheld or wearable communication devices, netbooks, notebook computers, tablet computers, laptops, Chromebooks, augmented reality (AR), virtual reality (VR), mixed reality (MR) or extended reality (XR) wireless headsets or other peripheral devices, wireless earbuds, other wearable devices, display devices (such as TVs, computer monitors or video gaming consoles), video game controllers, navigation systems, music or other audio or stereo devices, remote control devices, printers, kitchen appliances (including smart refrigerators) or other household appliances, key fobs (such as for passive keyless entry and start (PKES) systems), Internet of Things (IoT) devices, and vehicles, among other examples.

A single AP 102 and an associated set of STAs 104 may be referred to as an infrastructure basic service set (BSS), which is managed by the respective AP 102. FIG. 1 additionally shows an example coverage area 108 of the AP 102, which may represent a basic service area (BSA) of the wireless communication network 100. The BSS may be identified by STAs 104 and other devices by a service set identifier (SSID), as well as a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function (TSF) for establishing or maintaining timing synchronization with the AP 102. The AP 102 may provide access to external networks to various STAs 104 in the wireless communication network 100 via respective communication links 106.

To establish a communication link 106 with an AP 102, each of the STAs 104 is configured to perform passive or active scanning operations (“scans”) on frequency channels in one or more frequency bands (such as the 2.4 GHZ, 5 GHZ, 6 GHz, 45 GHz, or 60 GHz bands). To perform passive scanning, a STA 104 listens for beacons, which are transmitted by respective APs 102 at periodic time intervals referred to as target beacon transmission times (TBTTs). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The selected AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA 104 or to select among multiple APs 102 that together form an ESS including multiple connected BSSs. For example, the wireless communication network 100 may be connected to a wired or wireless distribution system that may enable multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some examples, STAs 104 may form networks without APs 102 or other equipment other than the STAs 104 themselves. One example of such a network is an ad hoc network (or wireless ad hoc network). Ad hoc networks may alternatively be referred to as mesh networks or P2P networks. In some examples, ad hoc networks may be implemented within a larger network such as the wireless communication network 100. In such examples, while the STAs 104 may be capable of communicating with each other through the AP 102 using communication links 106, STAs 104 also can communicate directly with each other via direct wireless communication links 110. Additionally, two STAs 104 may communicate via a direct wireless communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

In some networks, the AP 102 or the STAs 104, or both, may support applications associated with high throughput or low-latency requirements, or may provide lossless audio to one or more other devices. For example, the AP 102 or the STAs 104 may support applications and use cases associated with ultra-low-latency (ULL), such as ULL gaming, or streaming lossless audio and video to one or more personal audio devices (such as peripheral devices) or AR/VR/MR/XR headset devices. In scenarios in which a user uses two or more peripheral devices, the AP 102 or the STAs 104 may support an extended personal audio network enabling communication with the two or more peripheral devices. Additionally, the AP 102 and STAs 104 may support additional ULL applications such as cloud-based applications (such as VR cloud gaming) that have ULL and high throughput requirements.

As indicated above, in some implementations, the AP 102 and the STAs 104 may function and communicate (via the respective communication links 106) according to one or more of the IEEE 802.11 family of wireless communication protocol standards. These standards define the WLAN radio and baseband protocols for the physical (PHY) and MAC layers. The AP 102 and STAs 104 transmit and receive wireless communications (hereinafter also referred to as “Wi-Fi communications” or “wireless packets”) to and from one another in the form of PHY protocol data units (PPDUs).

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 102 and STAs 104 in the wireless communication network 100 may transmit PPDUs over an unlicensed spectrum, which may be a portion of spectrum that includes frequency bands traditionally used by Wi-Fi technology, such as the 2.4 GHZ, 5 GHz, 6 GHZ, 45 GHz, and 60 GHz bands. Some examples of the APs 102 and STAs 104 described herein also may communicate in other frequency bands that may support licensed or unlicensed communications. For example, the APs 102 or STAs 104, or both, also may be capable of communicating over licensed operating bands, where multiple operators may have respective licenses to operate in the same or overlapping frequency ranges. Such licensed operating bands may map to or be associated with frequency range designations of FR1 (410 MHz-7.125 GHZ), FR2 (24.25 GHZ-52.6 GHz), FR3 (7.125 GHz-24.25 GHZ), FR4a or FR4-1 (52.6 GHz-71 GHz), FR4 (52.6 GHz-114.25 GHZ), and FR5 (114.25 GHZ-300 GHz).

Each of the frequency bands may include multiple sub-bands and frequency channels (also referred to as subchannels). The terms “channel” and “subchannel” may be used interchangeably herein, as each may refer to a portion of frequency spectrum within a frequency band (such as a 20 MHz, 40 MHz, 80 MHz, or 160 MHz portion of frequency spectrum) via which communication between two or more wireless communication devices can occur. For example, PPDUs conforming to the IEEE 802.11n, 802.11ac, 802.11ax, 802.11be and 802.11bn standard amendments may be transmitted over one or more of the 2.4 GHZ, 5 GHZ, or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHZ, 160 MHZ, 240 MHZ, 320 MHz, 480 MHz, or 640 MHz by bonding together multiple 20 MHz channels.

An AP 102 may determine or select an operating or operational bandwidth for the STAs 104 in its BSS and select a range of channels within a band to provide that operating bandwidth. For example, the AP 102 may select sixteen 20 MHz channels that collectively span an operating bandwidth of 320 MHz. Within the operating bandwidth, the AP 102 may typically select a single primary 20 MHz channel on which the AP 102 and the STAs 104 in its BSS monitor for contention-based access schemes. In some examples, the AP 102 or the STAs 104 may be capable of monitoring only a single primary 20 MHz channel for packet detection (such as for detecting preambles of PPDUs). Conventionally, any transmission by an AP 102 or a STA 104 within a BSS must involve transmission on the primary 20 MHz channel. As such, in conventional systems, the transmitting device must contend on and win a TXOP on the primary channel to transmit anything at all. However, some APs 102 and STAs 104 supporting ultra-high reliability (UHR) communications or communication according to the IEEE 802.11bn standard amendment can be configured to operate, monitor, contend and communicate using multiple primary 20 MHz channels. Such monitoring of multiple primary 20 MHz channels may be sequential such that responsive to determining, ascertaining or detecting that a first primary 20 MHz channel is not available, a wireless communication device may switch to monitoring and contending using a second primary 20 MHz channel. Additionally, or alternatively, a wireless communication device may be configured to monitor multiple primary 20 MHz channels in parallel. In some examples, a first primary 20 MHz channel may be referred to as a main primary (M-Primary) channel and one or more additional, second primary channels may each be referred to as an opportunistic primary (O-Primary) channel. For example, if a wireless communication device measures, identifies, ascertains, detects, or otherwise determines that the M-Primary channel is busy or occupied (such as due to an overlapping BSS (OBSS) transmission), the wireless communication device may switch to monitoring and contending on an O-Primary channel. In some examples, the M-Primary channel may be used for beaconing and serving legacy client devices and an O-Primary channel may be specifically used by non-legacy (such as UHR- or IEEE 802.11bn-compatible) devices for opportunistic access to spectrum that may be otherwise under-utilized.

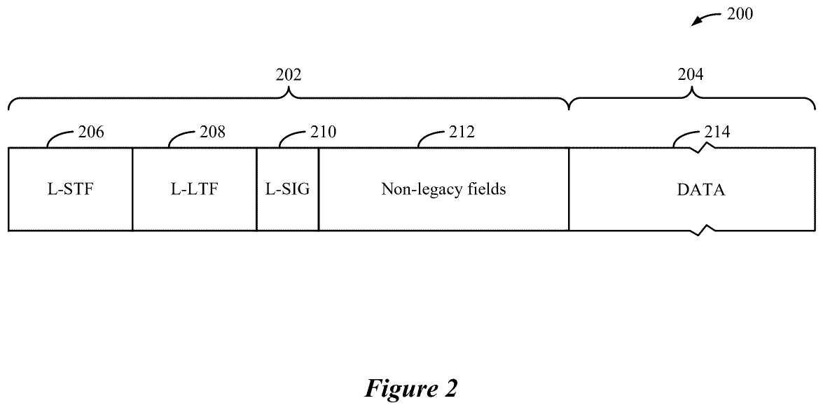

FIG. 2 shows an example protocol data unit (PDU) 200 usable for wireless communication between a wireless AP and one or more wireless STAs. For example, the AP and STAs may be examples of the AP 102 and the STAs 104 described with reference to FIG. 1. The PDU 200 can be configured as a PPDU. As shown, the PDU 200 includes a PHY preamble 202 and a PHY payload 204. For example, the preamble 202 may include a legacy portion that itself includes a legacy short training field (L-STF) 206, which may consist of two symbols, a legacy long training field (L-LTF) 208, which may consist of two symbols, and a legacy signal field (L-SIG) 210, which may consist of two symbols. The legacy portion of the preamble 202 may be configured according to the IEEE 802.11a wireless communication protocol standard. The preamble 202 also may include a non-legacy portion including one or more non-legacy fields 212, for example, conforming to one or more of the IEEE 802.11 family of wireless communication protocol standards.

The L-STF 206 generally enables a receiving device (such as an AP 102 or a STA 104) to perform coarse timing and frequency tracking and automatic gain control (AGC). The L-LTF 208 generally enables the receiving device to perform fine timing and frequency tracking and also to perform an initial estimate of the wireless channel. The L-SIG 210 generally enables the receiving device to determine (such as obtain, select, identify, detect, ascertain, calculate, or compute) a duration of the PDU and to use the determined duration to avoid transmitting on top of the PDU. The legacy portion of the preamble, including the L-STF 206, the L-LTF 208 and the L-SIG 210, may be modulated according to a binary phase shift keying (BPSK) modulation scheme. The payload 204 may be modulated according to a BPSK modulation scheme, a quadrature BPSK (Q-BPSK) modulation scheme, a quadrature amplitude modulation (QAM) modulation scheme, or another appropriate modulation scheme. The payload 204 may include a PSDU including a data field (DATA) 214 that, in turn, may carry higher layer data, for example, in the form of MAC protocol data units (MPDUs) or an aggregated MPDU (A-MPDU).

FIG. 3 shows an example of a process flow 300 that supports a signaling framework for unassociated AP coordination. In some examples, aspects of the process flow 300 may implement or be implemented by aspects of FIGS. 1 and 2. For example, the process flow 300 may include one or more APs 102 (such as an AP 102-a (a sharing AP), an AP 102-b (a shared AP), and an AP 102-c (another shared AP)), which may be examples of the APs as described herein with respect to FIGS. 1 and 2. In some aspects, the operations of the process flow 300 may illustrate one implementation of unassociated AP coordination in the context of TXS, which may allow for more efficient use of wireless medium.

In some examples, the APs 102 may be in an unassociated state with respect to each other. For example, the unassociated state may include an unauthenticated state, and the APs 102 may be in the unassociated state based on failure to exchange one or more association frames, failure to exchange one or more reassociation frames, failure to establish a security key, or any combination thereof. For example, the AP 102-a may not exchange the one or more association frames, may not exchange the one or more reassociation frames, may not establish the security key, or any combination thereof, with the AP 102-b, and thus the APs 102-a and 102-b may be in an unassociated state with respect to each other. Additionally, or alternatively, two devices (such as the APs 102, STAs 104) may be in an associated state with respect to each other based on (if) one or more of the two devices have requested to join (and become) a member of a BSS of the other of the two devices. For example, the APs 102 may be in the unassociated state with respect to each other in response to the both APs 102 failing to request to join a BSS of the other of the APs 102, failing to become a member of the BSS of the other of the APs 102, or both. However, each of the APs 102 may be in an associated state with one or more other entities, including one or more STAs 104.

The process flow 300 may illustrate one or more techniques for coordination between the APs 102 in the unassociated state. For example, the process flow 300 may illustrate such coordination in the context of TXS, and specifically for a shared AP (such as the AP 102-a) to indicate a TXOP return indication to a sharing AP. In some examples, the TXOP return indication may indicate that a remainder of a TXOP (such as after a shared portion of the TXOP) is being returned from the shared AP to the sharing AP. For such a scenario, some wireless communications systems may utilize a control end frame (CF-End). However, an AP transmitting a CF-end may reset a network allocation vector (NAV) for devices within a threshold range of the AP, which may cause contention and wireless signaling collisions in the wireless communications system. For example, the CF-end frame may reset an intra-BSS NAV for one or more STAs 104, a basic NAV for one or more other STAs 104, or both. Since the NAV is reset for these devices, the devices may contend to gain access to a shared wireless medium during a TXOP, which may cause a sharing AP (such as the AP 102-b) to lose control of the TXOP. For example, if the sharing AP is unable to access the shared wireless medium in short interframe space (SIFS) or within point coordination function (PCF) interframe space (PIFS) after receiving the CF-end frame, the sharing AP may lose control of the TXOP.

Additionally, or alternatively, some wireless communications systems may indicate (or communicate) a TXOP return indication via command and status (CAS) control information carried in a null quality of service (QOS) frame or a Data QoS frame. For example, a STA (such as a shared STA) may include such CAS control information in a QoS frame and transmit the QoS frame to an associated AP (such as a sharing AP). In some examples, APs 102 in an unassociated state may transmit null QoS frames to provide coordination information (such as a TXOP return indication). That is, conventionally one or more standards documents may not permit APs in an unassociated state to exchange a QoS null frame, and one or more standards documents may be updated to allow an exception for coordinating AP 102 (which are in an unassociated state, only coordinating APs) to exchange a null QoS frame, where the null QoS frame may carry one or more fields to facilitate coordination (such as content that may facilitate coordination). However, in some other examples, the APs 102 may not communicate null QoS frames and Data QoS frames while in the unassociated state. Accordingly, some unassociated APs (such as a sharing AP and a shared AP) may lack effective methods of communicating wireless medium coordination information, and specifically in the case of TXOPs.

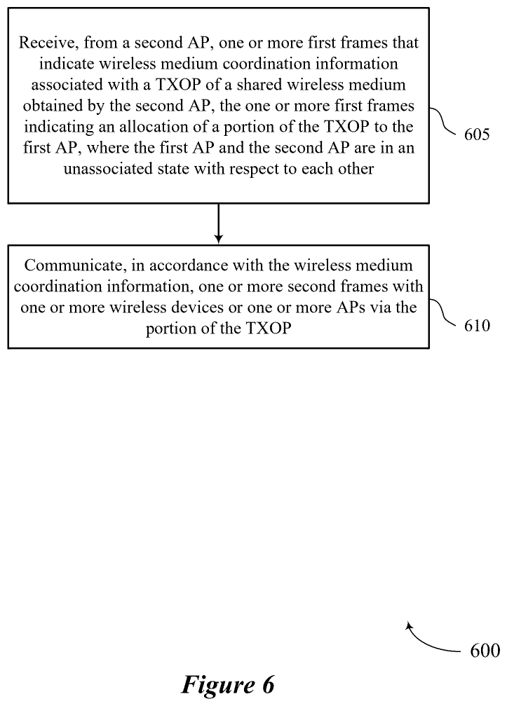

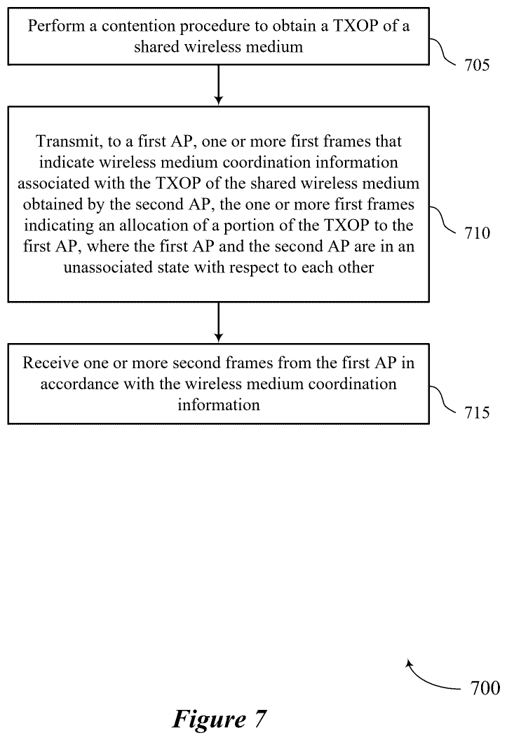

The process flow 300 may describe techniques for wireless medium coordination for unassociated APs. For example, the AP 102-a may transmit one or more frames (such as one or more second frames described with respect to FIGS. 6 and 7) to indicate the TXOP return indication to one or more of the APs 102-b and 102-c. In one implementation, the AP 102-a may transmit a management frame to the AP 102-b, where the management frame carries CAS control information, within the header of the frame, which may indicate a TXOP return indication (or any other information for unassociated AP coordination). For example, the management frame may include an HT control field, where the HT control field may include the CAS control information (or special (dedicated) A-control field) to indicate the TXOP return indication. In another implementation, the AP 102-a may transmit a management frame to the AP 102-b, where the management frame carries information in one or more header fields which may indicate a TXOP return indication (or any other information for unassociated AP coordination). For example, the management frame may include a public action frame (such as a management frame with a category of “public”, and an action of “coordinated AP” (“CAP”) or “C-TDMA”). Additionally, or alternatively, the management frame may be a CAP action frame, a C-TDMA action frame, or both. For example, the management frame may be a CAP notification, or C-TDMA notification frame (such as a dedicated frame for C-TDMA).

Additionally, or alternatively, an AP 102 may indicate the TXOP return indication via an extension to a management frame (such as a public action frame). In some examples, one or more standards documents may allow public action frames between unassociated STAs, APs, or both (such as a sharing AP and shared APs). For example, the AP 102-b and the APs 102-a and 102-c may exchange one or more CAP action frames, C-TDMA action frames, or both, in accordance with one or more rules indicated by one or more standards documents associated with coordinating APs (such as for class one management frames). The public action frames may indicate the TXOP return indication.

In some examples, the management frame also may carry information other than the TXOP return indication. For example, the information may include information associated with C-TDMA protocol (such as updating C-TDMA parameters for the AP 102-a (the shared AP)), information associated with use of the shared portion of the TXOP (such as an indication from a shared AP that the shared AP was unable to utilize one or more sections of a bandwidth associated with a shared portion of a TXOP, that the sharing AP may have accordingly lost control of an unused portion of the bandwidth for the remainder of the TXOP, or both), or both. Additionally, or alternatively, the management frame may carry no additional information in a body of the frame (such as a null action frame, which may carry only a medium access control MAC header containing a CAS Control field).

In some examples, because the CAS control information of a management frame carries the TXOP return indication, the management frame may not reset the NAV for devices within range of the AP 102-a (such as the CF-end frame). Additionally, if the CAS control information is within a header of the management frame, the AP 102-b (such as a sharing AP that receives the management frame) may react without processing a content of the management frame (such as in the body of the frame, which may reduce latency associated with implementing the TXOP return indication. For example, the AP 102-b may implement any changes associated with the TXOP return indication (such as determining a next shared AP, allocating portions of the TXOP) without waiting for processing of the body of the frame. Additionally, such techniques may leverage existing techniques, such as the communication of management frames.

Additionally, or alternatively, the AP 102-a may transmit an indication of the TXOP return indication within a field in the body the management frame (such as within a public action frame). In some examples, the TXOP may be within one or more fields associated with configuring CAP, C-TDMA, or both (such as a setup information field, an update field, a notification settings field, a UHR defined field in a public action frame). For example, a CAP or C-TDMA notification frame could carry the TXOP return indication within a field in a body of the CAP or C-TDMA frame. In some examples, if the AP 102-a communicates the TXOP return indication (or any other coordination information for unassociated APs) within a body of the management frame, the AP 102-b (the sharing AP) may process the payload of the frame (such as the management frame body) within a threshold duration (such as an SIFS time).

In some examples, the AP 102-b may indicate, to the AP 102-a, whether the AP 102-b has successfully received the one or more frame (such as the management frame or other implementations described herein). For example, the AP 102-b may transmit an acknowledgment (ACK) indication, a negative ACK (NACK), or another feedback indication. In a wireless communications system using a CF-end frame to communicate a TXOP return indication, a sharing AP may not transmit such a feedback indication, causing decreased performance and signaling ambiguity. In some examples, if the AP 102-a does not receive an ACK, receives a NACK, or does not receive feedback associated with the one or more frames, the AP 102-a may retransmit the one or more frames indicating the TXOP return indication.

Such feedback from the AP 102-b (a sharing AP) may be one implementation of a control response (such as a control response associated with SIFS time) associated with communicating the TXOP return indication (or any other information for unassociated AP coordination) between unassociated APs. In some examples, implementing a control response may allow the AP 102-b extra time (such as when compared to techniques without a control response from a sharing AP) to prepare for a set of actions subsequent to receiving the TXOP return indication (such as identifying a suitable device (STA 104, AP 102) within a BSS to serve, scheduling a subsequent shared AP for sharing). For example, the extra time may equal a sum of a control response time (such as the time to generate and transmit the control response), and two SIFS times.

In some examples, the AP 102-a may indicate the TXOP return indication to the AP 102-b based on a condition (such as within one or more scenarios). For example, the AP 102-a may transmit the TXOP return indication to the AP 102-b when the AP 102-b is configured to (or indicates an intention to) share one or more portions of the TXOP with more than one shared AP (such as one or more APs after the AP 102-a, including the AP 102-c). For example, the AP 102-b may indicate a list of a plurality of APs 102, and the list may indicate an order of the plurality of APs 102, such that each AP 102 of the list may receive an allocation of a portion of the TXOP according to the order. Additionally, or alternatively, the AP 102-a may transmit the TXOP return indication to the AP 102-b when the AP 102-b is configured to (or indicates an intention to) serve one or more devices (such as clients within a BSS) after the shared portion of the TXOP.

Additionally, or alternatively, the AP 102-a may receive a request to transmit the TXOP return indication. For example, a TXOP allocation frame (such as described herein at 314 of the process flow 300) may carry a request (such as a 1 bit indication) for the AP 102-a to send a TXOP return indication (or to not send a TXOP return indication) after using the shared portion of the TXOP. For example, the AP 102-b may request the TXOP return indication if the AP 102-a is the only AP with which the AP 102-b is sharing the TXOP, if the AP 102-a is a last AP with which the AP 102-b is sharing the TXOP (such as according to the order of the list of the plurality of APs), if the AP 102-b does not intend to use a remaining portion of the TXOP (such as after the one or more shared portions of the TXOP) for frame exchanges with devices within a BSS, or any combination thereof.

In some examples, communication of a TXOP return indication may be based on a capability of one or more APs 102, an operating mode of the one or more APs 102, or both. In some examples, an AP 102 (such as the AP 102-b, the AP 102-a, the AP 102-c, or any combination thereof) may advertise (such as transmit or broadcast an indication of) a capability, an operating mode, or both, with which the AP 102 may receive or send the TXOP return indication (or any other coordination information for unassociated APs). For example, the AP 102 may indicate the capability via a UHR capabilities element, a CAP capabilities element, or another element defined by one or more protocols (such as UHR). Additionally, or alternatively, the AP 102 may indicate the capability information via a beacon frame, a probe response, an association response, a reassociation response, a CAP frame, or another means (such as other frames defined by UHR). In some examples, the APs 102 may indicate the operational mode via a UHR operations element, a CAP operations element, a C-TDMA operations element, a schedule announcement frame (such as described at 306 of the process flow 300), or any combination thereof.

The AP 102-a may indicate the TXOP return indication (or other information associated with unassociated AP coordination) to one or more of the APs 102-b and 102-c via one or more other implementations. In one example, the AP 102-a may transmit an unsolicited clear to send frame to the AP 102-b (such as with a receive address (RA) field set to an address of the AP 102-b) to communicate the TXOP return indication. In some examples, the AP 102-a may set a duration field of the unsolicited clear to send frame to 0 to indicate the TXOP return indication. The AP 102-a also may transmit multiple clear to send frames, such as one per subchannel of the shared portion of the TXOP, which may indicate which subchannels the AP 102-a used (such as for communication with one or more STAs 104) during the portion of the TXOP.

As another example, the AP 102-a may transmit one or more request frames (such as in a multi-user request to send scenario) to indicate the TXOP return indication to the AP 102-b, where the one or more request frames may indicate the one or more subchannels of the TXOP that the AP 102-a may have used during the shared portion of the TXOP. Additionally, or alternatively, the AP 102-a may transmit duplicate of a request frame on the one or more subchannels of the TXOP to the AP 102-b. In some examples, the AP 102-b may respond to the shared AP (such as with a clear to send frame) via the respective subchannels.

Additionally, or alternatively, the AP 102-a (such as shared AP) may transmit an unsolicited block acknowledgment frame (such as a protected block acknowledgment frame) to indicate the TXOP return indication to the AP 102-b. In some examples, the block acknowledgment frame may be a multi-STA block acknowledgment variant, which may include the TXOP return indication. Additionally, a special value (such as a dedicated value) of a per association identifier (AID) traffic identifier (TID) field may indicate that the block acknowledgment frame is for communicating the TXOP return indication. In some examples, the AP 102-b (such as sharing AP) may not respond to the block acknowledgment frame from the AP 102-a, and thus the AP 102-a may not know if the block acknowledgment frame was lost.

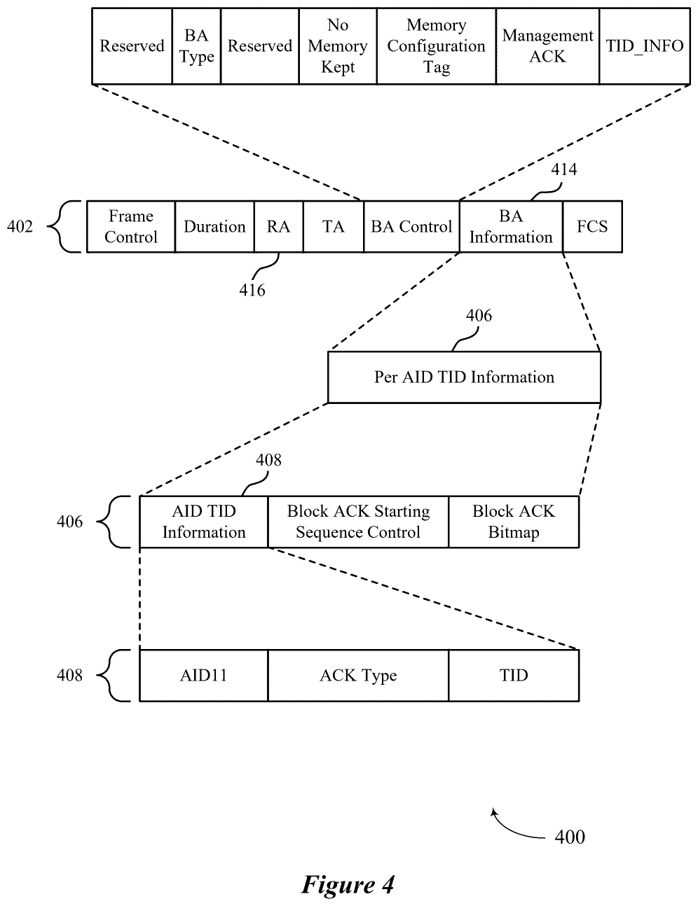

Additionally, or alternatively, the AP 102-b (such as sharing AP) may transmit a block acknowledgment request frame (such as a protected block acknowledgment request frame) to the AP 102-a, which may indicate the TXOP return indication. Accordingly, the sharing AP may transmit a block acknowledgment frame (such as a protected block acknowledgment frame), which may indicate to the AP 102-a that the AP 102-b received the block acknowledgment request frame. In some examples, a block acknowledgment request frame, a block acknowledgment frame, or both, may be protected if the AP 102-a and the AP 102-b (unassociated APs, a shared AP and a sharing AP, respectively) have formed a coordination relationship (such as a ‘trust’ relationship), have established an individual or group key, or both. As with other techniques described herein, a block acknowledgment request frame may solicit the block acknowledgment frame (such as a control response in SIFS), which may allot extra time for the sharing AP to prepare for subsequent operations. In some aspects, the use of a block acknowledgment frame, a block acknowledgment request frame, or both, for coordination between unassociated APs may be further described with respect to FIG. 4.

In some systems, if the shared AP (such as the AP 102-a) determines that the sharing AP (such as the AP 102-b) is unable or unavailable to receive the TXOP return indication via first link, the shared AP may send a TXOP return indication via another link where both the shared AP and the sharing AP (which may both be multi-link devices) may operate. For example, the shared AP may determine an unavailability of the sharing AP if the sharing AP does not transmit feedback (such as an ACK) in response to the TXOP return indication. Additionally, or alternatively, the sharing AP may inform the shared AP (such as via a message on another link) of the unavailability (and willingness) of the sharing AP to receive the TXOP return indication on one or more links between the sharing AP and the shared AP. The TXOP return indication on the other link may include a link identifier (such as a MAC address of the sharing AP or the shared AP) to identify a link of the TXOP which is being returned via the TXOP return indication.

As described, the AP 102-b may transmit a list (such as within one or more fields of the schedule announcement) that may indicate a plurality of APs 102 (such as a list including the APs 102-a and 102-c) and an order associated with the plurality of APs 102. Such techniques may be used in case of multiple APs sharing in C-TDMA, where a shared AP may send a (null) management frame to indicate that the shared AP is done using the TXOP and passing the TXOP to the next shared AP in the list without returning the TXOP to the sharing AP. In an example, a sharing AP, AP1, intends to share the TXOP with two shared APs (such as AP2 and AP3). After AP2 is finished with its transmission, AP2 sends a management frame to indicate that AP2 is passing the TXOP to the next shared AP in line (AP3). In some examples, this could be applicable in the case of early TXOP return by AP2 or when AP2 uses its allocated TXOP and then passes the TXOP to the next shared AP (AP3) without returning it to the sharing AP. In some examples, the list and order of shared APs (AP2, AP3) may be known to AP2 from the schedule announcement frame (or the TXOP allocation frame) from sharing AP. In some examples, a management frame may be sent to a group address so that both the sharing AP and the next shared AP (AP3) know about the TXOP passing from AP2 to AP3.

In such a case (such as a multiple AP sharing case in C-TDMA), the AP 102-a may transmit the TXOP return indication to a next shared AP (such as the AP 102-c) indicated by the list according to the order. For example, the TXOP return indication (or direct TXOP passing information) may indicate to the AP 102-c another shared portion of the TXOP and to begin using the other shared portion of the TXOP. In some examples, the AP 102-a may transmit the TXOP return indication to the AP 102-c without returning the TXOP to the AP 102-b. For example, the AP 102-a may transmit the TXOP return indication to the AP 102-c in the case of an early TXOP return by the AP 102-a (such as when the AP 102-a does not use all of the resources of the shared portion of the TXOP) or in a case where the AP 102-a does use the entirety of the shared portion of the TXOP. Such techniques of direct allocation of the TXOP from one shared TXOP to another shared TXOP may be known as passing the TXOP between shared APs, direct TXOP passing, or both.

As an example, the AP 102-b may be configured to share the TXOP with two shared APs (such as the AP 102-a and the AP 102-c), such that the list includes the two shared APs in an order. After receiving an allocation of a first portion of the TXOP from the AP 102-b, a first shared AP (such as the AP 102-a, according to the order) may perform one or more communication via the first portion. After performing the one or more communications, the first shared AP may transmit a frame (such as the one or more second frames described herein) to the second of the two shared APs (such as the AP 102-c, according to the order) to allocate a second portion of the TXOP (passing the TXOP) to the second shared AP. Thus, the AP 102-b may not receive an indication of the direct TXOP passing, reducing signaling overhead for the communication system.

In some examples, a schedule announcement (such as described at 306 of the process flow 300), a TXOP allocation (such as described at 314 of the process flow 300), or other wireless medium coordination information (such as described at 213 of the process flow 300) from the AP 102-b may indicate the list of the plurality of APs (such as to indicate a willingness to allow passing of a shared TXOP) and the order of the plurality of APs to one or more one or more APs 102 of the plurality of APs (such as the AP 102-a, the AP 102-c, a first quantity of APs 102 of the list). For example, the AP 102-b may set an address field of a frame indicating the list and the order to a group address associated with one or more of the plurality of APs. Thus, as an example, both the AP 102-b and a next shared AP (such as the AP 102-c) may determine that a first shared AP (such as the AP 102-a) will pass the TXOP to the next shared AP. Additionally, or alternatively, the AP 102-b may indicate whether direct TXOP passing is allowed via the schedule announcement, the TXOP allocation, the wireless medium coordination information, or any combination thereof.

In some systems, one or more APs 102 may utilize an identifier associated with the TXOP (such as a TXOP ID) for security. For example, each AP 102 on the plurality of APs 102 (as indicated by the list) may receive an indication of the identifier (such as via the schedule announcement, the wireless medium coordination information, the TXOP allocation). For example, the AP 102-a may include the identifier in a frame transmitted to a next shared TXOP (such as according to the order), which may indicate a passing of the TXOP to the next shared AP. In some examples, the identifier may include a MAC address of the AP 102-b (such as the sharing AP), a token associated with the TXOP, or any combination thereof, that the sharing AP includes in the schedule announcement or TXOP allocation frame.

In some examples, direct TXOP passing may occur based on a capability of the APs 102, and may be enabled via an operational mode of one or more shared APs (such as the APs 102-a and 102-c). For example, the AP 102-a, the AP 102-c, or both, may indicate whether they are capable of direct TXOP passing (such as communicating frames associated with direct TXOP passing) via exchanging one or more frames. For example, the AP 102-a may indicate such a capability via a UHR capabilities element, a CAP capabilities element, or another element defined by UHR, and the AP 102-a may indicate the capability information via a beacon indication, a probe response, an association response, a reassociation response, a CAP frame defined by UHR, or another frame. The AP 102-a may indicate the operational mode via a UHR operations element, a CAP operations element, a C-TDMA operations element, the schedule announcement, or any combination thereof.

Based on the indicated capability of each shared AP, the AP 102-b may indicate whether direct TXOP passing is allowed. For example, the sharing AP may utilize the schedule announcement frame, the TXOP allocation, or the wireless medium coordination information to indicate allowance or disallowance of direct TXOP sharing. Such techniques of direct TXOP sharing may apply in scenarios where the shared APs are within range of each other, when the schedule announcement provides TXOP sharing parameters (such as the list of the plurality of shared APs, the order of plurality of shared APs, whether traffic of a certain access category (AC) is allowed during shared portions of the TXOP), or both.

In scenarios of direct TXOP passing, a sharing AP (such as the AP 102-b) may receive a TXOP return indication and determine if the TXOP return indication indicates a direct TXOP pass between shared APs (as opposed to a return of the remainder of the TXOP to the sharing AP) based on a contents of the frame that communicates the TXOP return indication. For example, if an RA field of the frame is set to a group address, an address of a next shared AP, or any combination thereof, the sharing AP may determine that the TXOP return indication indicates a direct TXOP pass between shared APs. (such as shared AP indicating to one or more next shared APs that the next shared AP may begin using the TXOP (or a portion thereof)).

Direct TXOP passing between shared APs may incur one or more benefits. For example, direct TXOP passing may be associated with fewer frame exchanges between the sharing AP and the shared APs, which may save time and signaling overhead. Additionally, or alternatively, direct TXOP passing may reduce a TXOP allocation overhead, SIFS times associated with TXOP passing, and latency associated with clear to send responses.

In some examples, the TXOP return indication may be one example of wireless medium coordination information. The techniques described herein for transmitting wireless medium coordination information (such as short information between unassociated APs) via one or more frames may be extended to scenarios other that TXS. For example, in a C-TDMA scenario, an unassociated AP may configure the one or more frames to carry wireless medium coordination information within an A-control field (such as an HT control field) to another unassociated AP, where the information may provide a buffer status associated with the unassociated AP, a TXOP threshold (such as a capability or an operational mode), an intention to not participate in a poll as a response to receiving a polling frame from the sharing AP (such as a buffer status report poll, a schedule announcement frame), or any combination thereof.

In a coordinated spatial reuse (C-SR) scenario, the one or more frames (such as wireless medium coordination information in an A-control field of the one or more frames) may identify one or more APs 102 and whether the one or more APs 102 are allowed to participate in spatial reuse operations (such as performing a spatial reuse procedure). Additionally, or alternatively, the one or more frames may the wireless medium coordination information that announces a list of APs with which a transmitting AP matches or mismatches as a candidate C-SR AP pair.

In a coordinate beam forming (C-BF) scenario, an AP may use the one or more frames to request that a C-BF paired AP initiate and synchronize a C-BF channel sounding frame, one or more data frames, or both. In a non-primary channel access (NPCA) scenario, an AP may use the one or more frames to inform one or more neighboring APs, devices within a BSS, or both, to start or stop preceding TXOPs with an exchange of an initial control frame (ICF), an initial control response (ICR), or both (such as in a multiple user request to send and clear to send exchange). Additionally, or alternatively, the one or more frames may inform one or more neighboring APs of a one or more protection settings to use (such as NAV protection settings).

In a dynamic bandwidth expansion scenario, a transmitting AP 102 may transmit the one or more frames to indicate (such as in a binary fashion) whether a receiving AP may expand a respective bandwidth to overlap with a bandwidth of the transmitting AP. Additionally, or alternatively, the one or more frames may indicate one or more puncturing patterns (such as via a bitmap) that the receiving AP may use when expanding the respective bandwidth to overlap the bandwidth of the transmitting AP. As yet another example, in a coordinated restricted target wake time (C-RTWT) scenario, an AP may transmit the one or more frames to manage wireless medium access between one or more APs a restricted target wake time of one or the AP one or more APs (such as indicating one or more timing parameters for medium access for each AP).

In one or more of the scenarios, the one or more frames may include a block acknowledgment or block acknowledgment request frame (such as a multi-STA variant of a block acknowledgment frame) to indicate wireless medium coordination information to another AP. For example, the one or more frames may carry a special value (such as a dedicated value) within a per AID TID field, which may indicate one or more intentions of the one or more frames (such as for TXOP return), one or more intended APs, or both (as further described with respect to FIG. 4).

In the described scenarios, the one or more frames may be a management frame (such as a null management frame), a control frame (such as a protected control frame), a block acknowledgment frame, a block acknowledgment request frame, a multi-STA block acknowledgment variant, or any combination thereof. Additionally, in each of the scenarios, use of the one or more frames to indicate the wireless medium coordination information may be allowed or disallowed based on capabilities or operational modes available to the participating APs. For example, the capabilities for allowance may include a processing capability, as one or more actions for unassociated AP coordination may include significant processing (and thus a significant delay), and a receiving AP without satisfactory processing capabilities may not be capable of reacting quickly enough to apply changes within a same threshold durations (such as a TXOP), which may cause issues with subsequent operations.

To implement the one or more scenarios described, one or more standards documents may be updated to define one or more A-control fields (new A-control fields, dedicated A-control fields) to carry coordination information between unassociated APs. For example, each scenario described herein may be associated with one or more A-control fields. Additionally, or alternatively, each scenario may be associated with one or more dedicated A-control fields (dedicated to only the associated scenario), or one or more of the scenarios may be associated with one or more same A-control fields (such as a shared A-control field), and may be associated with different fields to indicate scenario-specific information.

In different scenarios, an AP may set a value of an RA field (such as an RA field 416 as described with respect to FIG. 4) of the one or more frames to be individually addressed or group addressed. For example, in a C-TDMA scenario, to communicate a TXOP return indication to a sharing AP, or when responding to a poll from a sharing AP, the RA field may be a MAC address of the sharing AP. Additionally, or alternatively, for C-TDMA direct TXOP passing between shared APs, the RA field may be group addressed (such as the sharing AP and one or more shared AP) or individually addressed (such as to a next shared AP). For a C-SR scenario, a sharing AP may set the RA field to a group address, as the information may be intended for multiple APs in within range of the shared AP.

In some examples, a special address (such as a dedicated group address value) may be defined (such as in a standards document) such that one or more target APs within range of the transmitting AP may process the information (and no other APs). Additionally, or alternatively, a sharing AP may determine the special address and provide the special address to one or more shared APs while exchanging frames to determine parameters for unassociated AP coordination (such as the wireless medium coordination information described at 312 of the process flow 300). In some examples, the one or more second frames may have an address set to a dedicated group address value for communicating coordination information between unassociated APs.

In the following description of the process flow 300, the operations may be performed in a different order than the order shown, or other operations may be added or removed from the process flow 300. For example, some operations may be left out of the process flow 300, may be performed in different orders or at different times, or other operations may be added to the process flow 300. Although the APs 102 are shown performing the operations of the process flow 300, some aspects of some operations also may be performed by one or more other wireless devices or network devices.

At 302, the AP 102-a (such as a first AP, a shared AP) may receive operating information from the AP 102-b (such as a second AP, a sharing AP), the AP 102-c (such as a third AP), or both. For example, the operating information may include an indication of a capability, an operational mode, or both, of the second AP, third AP, or both. In some examples, the capability, the operational mode, or both, may allow sharing of a TXOP between the APs 102. For example, the APs 102 may be configured with a capability or operational mode that allows TXS, and an AP 102 may indicate whether the AP 102 has such a capability, operational mode, or both, to the AP 102-a.

At 304, the AP 102-b may perform a contention procedure to obtain a TXOP of a shared wireless medium. For example, the AP 102-b may perform the contention procedure with one or more other APs 102, including the APs 102-a and 102-c. In some examples, the shared wireless medium may include a set of time and frequency resources for wireless communications.

At 306, the AP 102-b may transmit a schedule announcement (such as one or more frames indicating the schedule announcement) to one or more other APs, which may include one or more of the APs 102-a and 102-c. For example, the schedule announcement may be included in the one or more first frames (such as described with respect to FIGS. 6 and 7). In some examples, the schedule announcement may identify one or more APs 102 with whom the AP 102-b may share a portion of the TXOP. For example, the scheduling information may indicate the AP 102-a as an AP 102 with whom the AP 102-b may share the portion of the TXOP. In some examples, the schedule announcement may indicate a starting time and a time duration (such as an estimated starting time and estimated duration) of the portion of the TXOP.

At 308, the AP 102-a may transmit one or more frames indicating a clear to receive indication. For example, the AP 102-a may transmit the clear to receive indication based on the schedule announcement indicating the AP 102-a as an AP 102 with whom the AP 102-b may share the portion of the TXOP.

At 310, the AP 102-b may communicate with one or more STAs 104 via the TXOP. For example, the AP 102-b may exchange one or more frames with the one or more STAs, and the AP 102-b may be in an associated state with respect to the one or more STAs. In some examples, the AP 102-b may communicate with the one or more STAs 104 via another portion of the TXOP that is prior to the portion of the TXOP (which may be shared).

At 312, the AP 102-a may receive, from the AP 102-b, the one or more first frames, which may indicate wireless medium coordination information associated with the TXOP of the shared wireless medium. In some examples, the wireless medium coordination information may include an indication of a buffer status, a TXOP parameter, an intention to not participate in response to receiving a polling frame, one or more APs that are disallowed from participating in the TXOP, one or more spatial reuse candidate AP pairs, a coordinated beam forming request, a starting or stopping procedure for another (such as second) TXOP associated with another AP (such as AP 102-c), one or more network allocation vector protection settings, a dynamic bandwidth expansion indication, a coordinated target wake up time, or any combination thereof.

Additionally, or alternatively, the wireless medium coordination information may indicate (such as the AP 102-a may receive as part of the one or more first frames) a list that indicates a plurality of APs 102, and indicates an order of the plurality of APs 102 for sharing one or more portions of the TXOP in accordance with the order. For example, the AP 102-a may be a first AP of the plurality of APs 102 according to the order, and thus the AP 102-b may share the portion of the TXOP (such as a first portion of the TXOP of the one or more portions of the TXOP) with the AP 102-a. In some examples, the schedule announcement of 306 may be part of the one or more first frames.

Additionally, or alternatively, the operations at 312 may be combined with one or more other operations of the process flow 300. For example, one or more of the operations of 312, 306 (communicating the schedule announcement), and 308 (communicating the clear to receive frame) may be combined into one operation, such that the AP 102-b may transmit the schedule announcement and the wireless medium coordination information together (within the one or more first frames), and the AP 102-a may transmit the clear to receive frame in response to the schedule announcement and the wireless medium coordination information.

At 314, the one or more first frames may indicate, to the AP 102-a, an allocation of the portion of the TXOP. For example, the one or more first frames may indicate that the portion of the TXOP (such as the duration of time starting at the stat time indicated in the schedule announcement) are for use by the AP 102-a. In some examples, at 316, the AP 102-a may transmit a clear to send indication (such as part of the one or more second frames, described with respect to FIGS. 6 and 7) to the AP 102-a.

At 318, in some cases, the AP 102-a may communicate with one or more STAs 104 via the portion of the TXOP. For example, the AP 102-a may exchange one or more frames with the one or more STAs 104, and the one or more STAs 104 may be in an associated state with the AP 102-a. In some examples, the AP 102-a may utilize the portion of the TXOP (such as the entire portion, all of the resources in the portion) to communicate with the one or more STAs 104, may utilize a sub-portion of the portion of the TXOP to communicate with the one or more STAs 104, or may not utilize the portion of the TXOP to communicate with the one or more STAs.

At 320, the AP 102-a may communicate, in accordance with the wireless medium coordination information described at 312, one or more second frames (such as described in FIGS. 6 and 7) with one or more wireless devices (such as one or more STAs), one or more APs 102 (such as including one or more of the APs 102-b and 102-c), or both. In some examples, the AP 102-a may communicate the one or more second frames via the portion of the TXOP, or after the portion of the TXOP. In some examples, the one or more second frames may include a management frame, a control frame, or both. In some examples, the management frame may be a public action frame, an action frame, or both. Additionally, or alternatively, the management frame may not include a frame body field (such as a null management frame).

In some examples, the one or more second frames may indicate that the AP 102-a is returning (such as transferring, reallocating) a remainder of the TXOP in accordance with the wireless medium coordination information, where the remainder of the TXOP may include some or all of the portion of the TXOP. In some examples, transmission of the one or more second frames may indicate that the AP 102-a is returning the remainder of the TXOP regardless of a content of the one or more second frames. Additionally, or alternatively, the one or more second frames may include a TXOP return indication (such as one or more bits, to indicate that a remainder of the TXOP is being returned) within a header of the one or more second frames, a body of the one or more second frames, or both, in accordance with the wireless medium coordination information. For example, the one or more second frames may include the TXOP return indication within a high throughput (HT) control field of a header of the one or more second frames. Additionally, or alternatively, the one or more second frames may include one or more of a clear to send indication, a block acknowledgment frame, a block acknowledgment request frame, or any combination thereof, to indicate the TXOP return indication.

In some examples, the AP 102-a may transmit the one or more second frames to the AP 102-c, where the one or more second frames may include an indication of another (such as a second) allocation of another (such as a second) portion of the TXOP (such as from the remainder of the TXOP) to the third AP. For example, the list of the plurality of APs 102 (such as described in the wireless medium coordination information at 312) may include the AP 102-c after the AP 102-a in accordance with the order. Thus, the AP 102-a may allocate the other transmitting to the AP 102-c. Additionally, or alternatively, the AP 102-a may transmit, as part of the one or more second frames and to the AP 102-c, security information associated with the TXOP, the other portion of the TXOP, or both.

Additionally, or alternatively, transmitting the indication of the other allocation to the AP 102-c may be associated with the capability, the operational mode, or both, of the AP 102-a, the AP 102-c, or both (such as described at 302).

Additionally, or alternatively, the one or more second frames may include a frame indicating, to the AP 102-b, one or more subchannels of the portion of the TXOP over which the AP 102-a may have communicated with the one or more STAs 104 (such as at 318), the one or more second frames, or both. In some examples, the AP 102-a also may set an address field of the one or more second frames to a special address (such as a dedicated group address indicating one or more APs 102 including the AP 102-b, the AP 102-c, or both) for communicating coordination information between unassociated APs.

In some cases (such as if the AP 102-a send the one or more second frames to the AP 102-b), at 322, the AP 102-a may receive, from the AP 102-b, one or more third frames that comprise feedback associated with the one or more second frames. For example, the feedback may indicate whether the AP 102-b successfully received the one or more second frames.

FIG. 4 shows an example of a block acknowledgment frame format 400 that supports a signaling framework for unassociated AP coordination. In some examples, aspects of the block acknowledgment frame format 400 may implement or be implemented by aspects of FIGS. 1-3. For example, the block acknowledgment frame format 400 may include a block acknowledgment frame 402, an RA field 416, and a per AID TID information field 406, which may be examples of the block acknowledgment frames, RA fields, and per AID TID information as described herein with respect to FIGS. 1-3. In some aspects, the block acknowledgment frame format 400 may illustrate techniques for utilizing the block acknowledgment frame 402 to support unassociated AP coordination, which may allow for more efficient utilization of wireless resources via a framework that may be readily implemented.

As described with respect to FIG. 3, an AP may transmit a block acknowledgment request (BAR) frame 402 (such as a multi-user block acknowledgment request or a multi-TID block acknowledgement request) to communicate unassociated AP coordination information, including a TXOP return indication. Such a BAR frame may be followed by a multi-STA block acknowledgment frame from the receiving AP (such as the sharing AP). For example, a shared AP may communicate (such as transmit) the TXOP return indication via a multi-user block acknowledgment request or a multi-TID block acknowledgement request followed by receiving a multi-STA block acknowledgment frame from a sharing AP, or the shared AP may communicate the TXOP via a multi-STA block acknowledgment frame (such as without a response from the sharing AP or the shared AP). The soliciting BAR frame may include a special value in a field (such as the TID field or within a reserved field, such as the reserved field in the Per-TID Info field of the multi-TID BAR variant) to indicate that it is TXOP return frame.

In some examples, the AP may transmit the block acknowledgment frame 402 including a special value (such as a dedicated value) that indicates that the frame (such as a block acknowledgment request frame or a block acknowledgment frame) is (or indicates, includes) the TXOP return indication. For example, the frame may carry special information (such as a TXOP return indication for returning the TXOP to the sharing AP or for direct TXOP passing with one or more shared APs). In one example, the per AID TID information field 406 may carry a special AID value (such as a dedicated AID value) to indicate a purpose of the block acknowledgment frame 402. For example, a block acknowledgment information field 414 of the block acknowledgment frame 402 may include the per AID TID information field 406. The per AID TID information field 406 may include one or more fields that may include the special value and indicate the purpose of the block acknowledgment frame 402. For example, an AID TID information field 408 of the per AID TID information field 406 may include one or more fields that may indicate the special value and the purpose of the block acknowledgment frame 402.

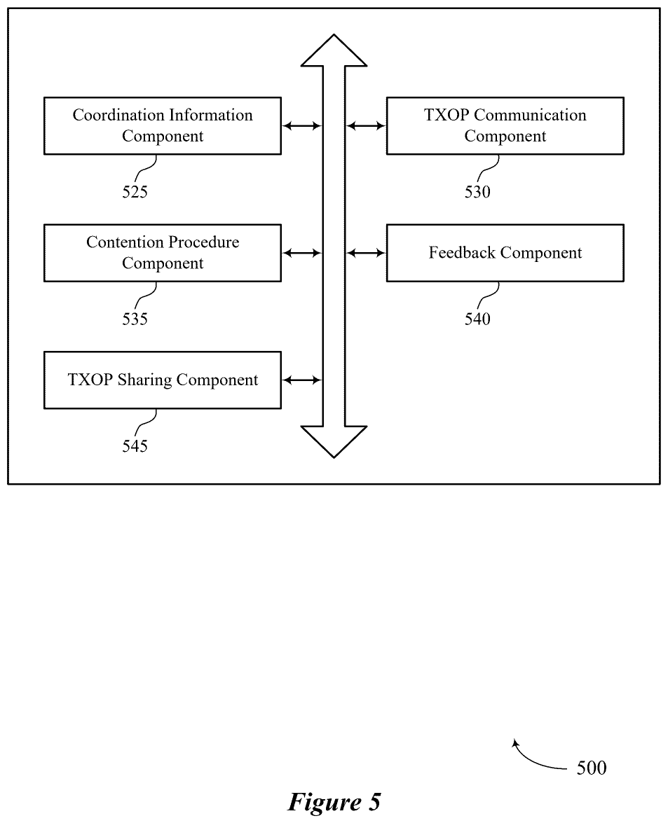

FIG. 5 shows a block diagram of an example wireless communication device 500 that supports a signaling framework for unassociated AP coordination. In some examples, the wireless communication device 500 is configured to perform the processes 600 and 700 described with reference to FIGS. 6 and 7, respectively. The wireless communication device 500 may include one or more chips, SoCs, chipsets, packages, components or devices that individually or collectively constitute or include a processing system. The processing system may interface with other components of the wireless communication device 500, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the wireless communication device 500 may transmit the information output from the chip. In such an example, the second interface may refer to an interface between the processing system of the chip and a reception component, such that the wireless communication device 500 may receive information that is then passed to the processing system. In some such examples, the first interface also may obtain information, such as from the transmission component, and the second interface also may output information, such as to the reception component.

The processing system of the wireless communication device 500 includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or ROM, or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally, or alternatively, in some examples, one or more of the processors may be preconfigured to perform various functions or operations described herein without requiring configuration by software. The processing system may further include or be coupled with one or more modems (such as a Wi-Fi (such as IEEE compliant) modem or a cellular (such as 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, the wireless communication device 500 can be configurable or configured for use in an AP, such as the AP 102 described with reference to FIG. 1. In some other examples, the wireless communication device 500 can be an AP that includes such a processing system and other components including multiple antennas. The wireless communication device 500 is capable of transmitting and receiving wireless communications in the form of, for example, wireless packets. For example, the wireless communication device 500 can be configurable or configured to transmit and receive packets in the form of physical layer PPDUs and MPDUs conforming to one or more of the IEEE 802.11 family of wireless communication protocol standards. In some other examples, the wireless communication device 500 can be configurable or configured to transmit and receive signals and communications conforming to one or more 3GPP specifications including those for 5G NR or 6G. In some examples, the wireless communication device 500 also includes or can be coupled with one or more application processors which may be further coupled with one or more other memories. In some examples, the wireless communication device 500 further includes at least one external network interface coupled with the processing system that enables communication with a core network or backhaul network that enables the wireless communication device 500 to gain access to external networks including the Internet.

The wireless communication device 500 includes a coordination information component 525, a TXOP communication component 530, a contention procedure component 535, a feedback component 540, and a TXOP sharing component 545. Portions of one or more of the coordination information component 525, the TXOP communication component 530, the contention procedure component 535, the feedback component 540, and the TXOP sharing component 545 may be implemented at least in part in hardware or firmware. For example, one or more of the coordination information component 525, the TXOP communication component 530, the contention procedure component 535, the feedback component 540, and the TXOP sharing component 545 may be implemented at least in part by at least a processor or a modem. In some examples, portions of one or more of the coordination information component 525, the TXOP communication component 530, the contention procedure component 535, the feedback component 540, and the TXOP sharing component 545 may be implemented at least in part by a processor and software in the form of processor-executable code stored in memory.

The wireless communication device 500 may support wireless communications in accordance with examples as disclosed herein. The coordination information component 525 is configurable or configured to receive, from a second AP, one or more first frames that indicate wireless medium coordination information associated with a TXOP of a shared wireless medium obtained by the second AP, the one or more first frames indicating an allocation of a portion of the TXOP to the first AP, where the first AP and the second AP are in an unassociated state with respect to each other. The TXOP communication component 530 is configurable or configured to communicate, in accordance with the wireless medium coordination information, one or more second frames with one or more wireless devices or one or more APs via the portion of the TXOP.

In some examples, the one or more APs include the second AP. In some examples, the one or more second frames include a TXOP return indication within a header of the one or more second frames, a body of the one or more second frames, or both, in accordance with the wireless medium coordination information.

In some examples, the TXOP return indication is within a field of a header of the one or more second frames.

In some examples, the one or more second frames indicate that a remainder of the TXOP is being returned.

In some examples, to support communicating the one or more second frames, the TXOP communication component 530 is configurable or configured to transmit, to the second AP, one or more of a clear to send indication, a block acknowledgment frame, a block acknowledgment request frame, or any combination thereof, to indicate a TXOP return indication to indicate that a remainder of the TXOP is being returned.

In some examples, the block acknowledgment frame, the block acknowledgment request frame, or both, include a special AID value in a per AID TID field, where the special AID value indicates the TXOP return indication.

In some examples, the one or more second frames include a management frame or a control frame.

In some examples, the one or more second frames include the management frame, and the management frame is a public action frame or an action frame.

In some examples, the one or more second frames include the management frame, and the management frame does not include a frame body field.

In some examples, the feedback component 540 is configurable or configured to receive, from the second AP, one or more third frames that include feedback that indicates whether the one or more second frames were successfully received at the second AP.

In some examples, to support communicating the one or more second frames, the TXOP communication component 530 is configurable or configured to transmit, to the second AP, a frame indicating one or more subchannels of the portion of the TXOP over which the first AP communicated the one or more second frames.

In some examples, to support receiving the one or more first frames, the coordination information component 525 is configurable or configured to receive a list that indicates a set of multiple APs and an order of the set of multiple APs for sharing of one or more portions of the TXOP in accordance with the order.

In some examples, to support communicating the one or more second frames, the TXOP communication component 530 is configurable or configured to transmit, to a third AP, an indication of a second allocation of a second portion of the TXOP to the third AP in accordance with the order.

In some examples, to support communicating the one or more second frames, the TXOP communication component 530 is configurable or configured to transmit, to the third AP, security information associated with the TXOP, the second portion of the TXOP, or both.

In some examples, the first AP and the second AP are in the unassociated state with respect to each other based at least in part on the first AP failing to request to join a basic service set associated with the second AP.

In some examples, the TXOP sharing component 545 is configurable or configured to receive an indication of a capability, an operational mode, or both, of the second AP, third AP, or both, to allow sharing of the TXOP, where transmitting the indication of the second allocation to the third AP is associated with the capability, the operational mode, or both, of the second AP, the third AP, or both.

In some examples, the first AP and the second AP are in the unassociated state with respect to each other based on the first AP failing to request to join a BSS associated with the second AP.

In some examples, the wireless medium coordination information includes an indication of a buffer status, a TXOP parameter, an intention to not participate in response to receiving a polling frame, one or more APs that are disallowed from participating in the TXOP, one or more spatial reuse candidate AP pairs, a coordinated beam forming request, a starting or stopping procedure for a second TXOP associated with a third AP, one or more network allocation vector protection settings, a dynamic bandwidth expansion indication, a coordinated target wake up time, or any combination thereof.

In some examples, the TXOP communication component 530 is configurable or configured to set an address field of the one or more second frames to a special address for communicating coordination information between unassociated APs.

In some examples, the unassociated state includes an unauthenticated state. In some examples, the first AP and the second AP are in the unassociated state based on failure to exchange one or more association frames, failure to exchange one or more reassociation frames, failure to establish a security key, or any combination thereof.

Additionally, or alternatively, the wireless communication device 500 may support wireless communications in accordance with examples as disclosed herein. The contention procedure component 535 is configurable or configured to perform a contention procedure to obtain a TXOP of a shared wireless medium. In some examples, the coordination information component 525 is configurable or configured to transmit, to a first AP, one or more first frames that indicate wireless medium coordination information associated with the TXOP of the shared wireless medium obtained by the second AP, the one or more first frames indicating an allocation of a portion of the TXOP to the first AP, where the first AP and the second AP are in an unassociated state with respect to each other. In some examples, the TXOP communication component 530 is configurable or configured to receive one or more second frames from the first AP in accordance with the wireless medium coordination information.

In some examples, the one or more second frames include a TXOP return indication in accordance with the wireless medium coordination information. In some examples, the TXOP return indication indicates that a remainder of the TXOP is being returned.

In some examples, the TXOP return indication is within a field of a header of the one or more second frames.

In some examples, the one or more second frames indicate that a remainder of the TXOP is being returned.

In some examples, to support receiving the one or more second frames, the TXOP communication component 530 is configurable or configured to receive, from the first AP, one or more of a clear to send indication, a block acknowledgment frame, a block acknowledgment request frame, or any combination thereof, to indicate a TXOP return indication to indicate that a remainder of the TXOP is being returned.

In some examples, the one or more second frames include a management frame or a control frame.

In some examples, the one or more second frames include the management frame, and the management frame is a public action frame or an action frame.

In some examples, the one or more second frames include the management frame, and the management frame does not include a frame body field.

In some examples, the feedback component 540 is configurable or configured to transmit, to the first AP, one or more third frames that include feedback that indicates whether the one or more second frames were successfully received at the second AP.

In some examples, to support receiving the one or more second frames, the TXOP communication component 530 is configurable or configured to receive, from the first AP, a frame indicating one or more subchannels of the portion of the TXOP over which the first AP communicated one or more third frames.

In some examples, to support transmitting the one or more first frames, the coordination information component 525 is configurable or configured to transmit a list that indicates a set of multiple APs and an order of the set of multiple APs for sharing of one or more portions of the TXOP in accordance with the order.

In some examples, the TXOP sharing component 545 is configurable or configured to transmit, to the first AP, an indication of a capability, an operational mode, or both, of the second AP to allow sharing of the TXOP.

In some examples, the wireless medium coordination information includes an indication of a buffer status, a TXOP parameter, an intention to not participate in response to receiving a polling frame, one or more APs that are disallowed from participating in the TXOP, one or more spatial reuse candidate AP pairs, a coordinated beam forming request, a starting or stopping procedure for a second TXOP associated with an AP, one or more network allocation vector protection settings, a dynamic bandwidth expansion indication, a coordinated target wake up time, or any combination thereof.

In some examples, an address field of the one or more second frames is set to a special address for communicating coordination information between unassociated APs.

In some examples, the unassociated state includes an unauthenticated state. In some examples, the first AP and the second AP are in the unassociated state based on failure to exchange one or more association frames, failure to exchange one or more reassociation frames, failure to establish a security key, or any combination thereof.

FIG. 6 shows a flowchart illustrating an example process 600 performable by or at a first wireless AP that supports a signaling framework for unassociated AP coordination. The operations of the process 600 may be implemented by a first wireless AP or its components as described herein. For example, the process 600 may be performed by a wireless communication device, such as the wireless communication device 500 described with reference to FIG. 5, operating as or within a wireless AP. In some examples, the process 600 may be performed by a wireless AP, such as one of the APs 102 described with reference to FIG. 1.

In some examples, in 605, the first wireless AP may receive, from a second AP, one or more first frames that indicate wireless medium coordination information associated with a TXOP of a shared wireless medium obtained by the second AP, the one or more first frames indicating an allocation of a portion of the TXOP to the first AP, where the first AP and the second AP are in an unassociated state with respect to each other. The operations of 605 may be performed in accordance with examples as disclosed herein. In some implementations, aspects of the operations of 605 may be performed by a coordination information component 525 as described with reference to FIG. 5.

In some examples, in 610, the first wireless AP may communicate, in accordance with the wireless medium coordination information, one or more second frames with one or more wireless devices or one or more APs via the portion of the TXOP. The operations of 610 may be performed in accordance with examples as disclosed herein. In some implementations, aspects of the operations of 610 may be performed by a TXOP communication component 530 as described with reference to FIG. 5.

FIG. 7 shows a flowchart illustrating an example process 700 performable by or at a second wireless AP that supports a signaling framework for unassociated AP coordination. The operations of the process 700 may be implemented by a second wireless AP or its components as described herein. For example, the process 700 may be performed by a wireless communication device, such as the wireless communication device 500 described with reference to FIG. 5, operating as or within a wireless AP. In some examples, the process 700 may be performed by a wireless AP, such as one of the APs 102 described with reference to FIG. 1.

In some examples, in 705, the second wireless AP may perform a contention procedure to obtain a TXOP of a shared wireless medium. The operations of 705 may be performed in accordance with examples as disclosed herein. In some implementations, aspects of the operations of 705 may be performed by a contention procedure component 535 as described with reference to FIG. 5.

In some examples, in 710, the second wireless AP may transmit, to a first AP, one or more first frames that indicate wireless medium coordination information associated with the TXOP of the shared wireless medium obtained by the second AP, the one or more first frames indicating an allocation of a portion of the TXOP to the first AP, where the first AP and the second AP are in an unassociated state with respect to each other. The operations of 710 may be performed in accordance with examples as disclosed herein. In some implementations, aspects of the operations of 710 may be performed by a coordination information component 525 as described with reference to FIG. 5.

In some examples, in 715, the second wireless AP may receive one or more second frames from the first AP in accordance with the wireless medium coordination information. The operations of 715 may be performed in accordance with examples as disclosed herein. In some implementations, aspects of the operations of 715 may be performed by a TXOP communication component 530 as described with reference to FIG. 5.

Implementation examples are described in the following numbered clauses:

Aspect 1: A method for wireless communications at a first wireless AP, comprising: receiving, from a second AP, one or more first frames that indicate wireless medium coordination information associated with a TXOP of a shared wireless medium obtained by the second AP, the one or more first frames indicating an allocation of a portion of the TXOP to the first AP, wherein the first AP and the second AP are in an unassociated state with respect to each other; and communicating, in accordance with the wireless medium coordination information, one or more second frames with one or more wireless devices or one or more APs via the portion of the TXOP.

Aspect 2: The method of aspect 1, wherein the one or more APs comprise the second AP, and the one or more second frames comprise a TXOP return indication within a header of the one or more second frames, a body of the one or more second frames, or both, in accordance with the wireless medium coordination information.

Aspect 3: The method of aspect 2, wherein the TXOP return indication is within a field of a header of the one or more second frames.

Aspect 4: The method of any of aspects 1 through 3, wherein the one or more second frames indicate that a remainder of the TXOP is being returned.

Aspect 5: The method of any of aspects 1 through 4, wherein communicating the one or more second frames comprises: transmitting, to the second AP, one or more of a clear to send indication, a block acknowledgement frame, a block acknowledgment request frame, or any combination thereof, to indicate a TXOP return indication to indicate that a remainder of the TXOP is being returned.

Aspect 6: The method of any of aspects 1 through 5, wherein the one or more second frames comprise a management frame or a control frame.

Aspect 7: The method of aspect 6, wherein the one or more second frames comprise the management frame, and the management frame is a public action frame or an action frame.

Aspect 8: The method of any of aspects 6 through 7, wherein the one or more second frames comprise the management frame, and the management frame does not include a frame body field.

Aspect 9: The method of any of aspects 1 through 8, wherein the one or more APs comprise the second AP, further comprising: receiving, from the second AP, one or more third frames that comprise feedback that indicates whether the one or more second frames were successfully received at the second AP.

Aspect 10: The method of any of aspects 1 through 9, wherein communicating the one or more second frames comprises: transmitting, to the second AP, a frame indicating one or more subchannels of the portion of the TXOP over which the first AP communicated the one or more second frames.

Aspect 11: The method of any of aspects 1 through 10, wherein receiving the one or more first frames comprises: receiving a list that indicates a plurality of APs and an order of the plurality of APs for sharing of one or more portions of the TXOP in accordance with the order.

Aspect 12: The method of aspect 11, wherein communicating the one or more second frames comprises: transmitting, to a third AP, an indication of a second allocation of a second portion of the TXOP to the third AP in accordance with the order.

Aspect 13: The method of aspect 12, wherein communicating the one or more second frames comprises: transmitting, to the third AP, security information associated with the TXOP, the second portion of the TXOP, or both.

Aspect 14: The method of any of aspects 12 through 13, further comprising: receiving an indication of a capability, an operational mode, or both, of the second AP, third AP, or both, to allow sharing of the TXOP, wherein transmitting the indication of the second allocation to the third AP is associated with the capability, the operational mode, or both, of the second AP, the third AP, or both.

Aspect 15: The method of any of aspects 1 through 14, wherein the wireless medium coordination information comprises an indication of a buffer status, a TXOP parameter, an intention to not participate in response to receiving a polling frame, one or more APs that are disallowed from participating in the TXOP, one or more spatial reuse candidate AP pairs, a coordinated beam forming request, a starting or stopping procedure for a second TXOP associated with a third AP, one or more NAV protection settings, a dynamic bandwidth expansion indication, a coordinated target wake up time, or any combination thereof.

Aspect 16: The method of any of aspects 1 through 15, further comprising: setting an address field of the one or more second frames to a special address for communicating coordination information between unassociated APs.

Aspect 17: The method of any of aspects 1 through 16, wherein the unassociated state comprises an unauthenticated state, and the first AP and the second AP are in the unassociated state based at least in part on failure to exchange one or more association frames, failure to exchange one or more reassociation frames, failure to establish a security key, or any combination thereof.

Aspect 18: The method of any of aspects 1 through 17, wherein the first AP and the second AP are in the unassociated state with respect to each other based at least in part on the first AP failing to request to join a basic service set associated with the second AP.

Aspect 19: A method for wireless communications at a second wireless AP, comprising: performing a contention procedure to obtain a TXOP of a shared wireless medium; transmitting, to a first AP, one or more first frames that indicate wireless medium coordination information associated with the TXOP of the shared wireless medium obtained by the second AP, the one or more first frames indicating an allocation of a portion of the TXOP to the first AP, wherein the first AP and the second AP are in an unassociated state with respect to each other; and receiving one or more second frames from the first AP in accordance with the wireless medium coordination information

Aspect 20: The method of aspect 19, wherein the one or more second frames comprise a TXOP return indication in accordance with the wireless medium coordination information, the TXOP return indication indicates that a remainder of the TXOP is being returned.

Aspect 21: The method of aspect 20, wherein the TXOP return indication is within a field of a header of the one or more second frames.

Aspect 22: The method of any of aspects 19 through 21, wherein the one or more second frames indicate that a remainder of the TXOP is being returned.

Aspect 23: The method of any of aspects 19 through 22, wherein receiving the one or more second frames comprises: receiving, from the first AP, one or more of a clear to send indication, a block acknowledgement frame, a block acknowledgment request frame, or any combination thereof, to indicate a TXOP return indication to indicate that a remainder of the TXOP is being returned.

Aspect 24: The method of any of aspects 19 through 23, wherein the one or more second frames comprise a management frame or a control frame.

Aspect 25: The method of aspect 24, wherein the one or more second frames comprise the management frame, and the management frame is a public action frame or an action frame.

Aspect 26: The method of any of aspects 24 through 25, wherein the one or more second frames comprise the management frame, and the management frame does not include a frame body field.

Aspect 27: The method of any of aspects 19 through 26, further comprising: transmitting, to the first AP, one or more third frames that comprise feedback that indicates whether the one or more second frames were successfully received at the second AP.

Aspect 28: The method of any of aspects 19 through 27, wherein receiving the one or more second frames comprises: receiving, from the first AP, a frame indicating one or more subchannels of the portion of the TXOP over which the first AP communicated one or more third frames.

Aspect 29: The method of any of aspects 19 through 28, wherein transmitting the one or more first frames comprises: transmitting a list that indicates a plurality of APs and an order of the plurality of APs for sharing of one or more portions of the TXOP in accordance with the order.

Aspect 30: The method of any of aspects 19 through 29, further comprising: transmitting, to the first AP, an indication of a capability, an operational mode, or both, of the second AP to allow sharing of the TXOP.

Aspect 31: The method of any of aspects 19 through 30, wherein the wireless medium coordination information comprises an indication of a buffer status, a TXOP parameter, an intention to not participate in response to receiving a polling frame, one or more APs that are disallowed from participating in the TXOP, one or more spatial reuse candidate AP pairs, a coordinated beam forming request, a starting or stopping procedure for a second TXOP associated with an AP, one or more NAV protection settings, a dynamic bandwidth expansion indication, a coordinated target wake up time, or any combination thereof.

Aspect 32: The method of any of aspects 19 through 31, wherein an address field of the one or more second frames is set to a special address for communicating coordination information between unassociated APs.

Aspect 33: The method of any of aspects 19 through 32, wherein the unassociated state comprises an unauthenticated state, and the first AP and the second AP are in the unassociated state based at least in part on failure to exchange one or more association frames, failure to exchange one or more reassociation frames, failure to establish a security key, or any combination thereof.

Aspect 34: The method of any of aspects 19 through 33, wherein the first AP and the second AP are in the unassociated state with respect to each other based at least in part on the first AP failing to request to join a basic service set associated with the second AP.

Aspect 35: A first wireless AP for wireless communications, comprising one or more memories storing processor-executable code, and one or more processors coupled with the one or more memories and individually or collectively operable to execute the code to cause the first wireless AP to perform a method of any of aspects 1 through 18.

Aspect 36: A first wireless AP for wireless communications, comprising at least one means for performing a method of any of aspects 1 through 18.

Aspect 37: A non-transitory computer-readable medium storing code for wireless communications, the code comprising instructions executable by one or more processors to perform a method of any of aspects 1 through 18.

Aspect 38: A second wireless AP for wireless communications, comprising one or more memories storing processor-executable code, and one or more processors coupled with the one or more memories and individually or collectively operable to execute the code to cause the second wireless AP to perform a method of any of aspects 19 through 34.

Aspect 39: A second wireless AP for wireless communications, comprising at least one means for performing a method of any of aspects 19 through 34.

Aspect 40: A non-transitory computer-readable medium storing code for wireless communications, the code comprising instructions executable by one or more processors to perform a method of any of aspects 19 through 34.

As used herein, the term “determine” or “determining” encompasses a wide variety of actions and, therefore, “determining” can include calculating, computing, processing, deriving, estimating, investigating, looking up (such as via looking up in a table, a database, or another data structure), inferring, ascertaining, or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing and other such similar actions.

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b. Furthermore, as used herein, a phrase referring to “a” or “an” element refers to one or more of such elements acting individually or collectively to perform the recited function(s). Additionally, a “set” refers to one or more items, and a “subset” refers to less than a whole set, but non-empty.

As used herein, “based on” is intended to be interpreted in the inclusive sense, unless otherwise explicitly indicated. For example, “based on” may be used interchangeably with “based at least in part on,” “associated with,” “in association with,” or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions, or information.

The various illustrative components, logic, logical blocks, modules, circuits, operations, and algorithm processes described in connection with the examples disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

What is claimed is:

1. A first wireless access point (AP), comprising:
a processing system that includes processor circuitry and memory circuitry that stores code, the processing system configured to cause the first wireless AP to:
receive, from a second wireless AP, one or more first frames that indicate wireless medium coordination information associated with a transmission opportunity of a shared wireless medium obtained by the second wireless AP, the one or more first frames indicating an allocation of a portion of the transmission opportunity to the first wireless AP, wherein the first wireless AP and the second wireless AP are in an unassociated state with respect to each other; and
communicate, in accordance with the wireless medium coordination information, one or more second frames with one or more wireless devices or one or more APs via the portion of the transmission opportunity.

2. The first wireless AP of claim 1, wherein:
the one or more APs comprise the second wireless AP, and
the one or more second frames comprise a transmission opportunity return indication within a header of the one or more second frames, a body of the one or more second frames, or both, in accordance with the wireless medium coordination information.

3. The first wireless AP of claim 2, wherein the transmission opportunity return indication is within a field of a header of the one or more second frames.

4. The first wireless AP of claim 1, wherein the one or more second frames indicate that a remainder of the transmission opportunity is being returned.

5. The first wireless AP of claim 1, wherein, to communicate the one or more second frames, the processing system is configured to cause the first wireless AP to:
transmit, to the second wireless AP, one or more of a clear to send indication, a block acknowledgment frame, a block acknowledgment request frame, or any combination thereof, to indicate a transmission opportunity return indication to indicate that a remainder of the transmission opportunity is being returned.

6. The first wireless AP of claim 5, wherein the block acknowledgment frame, the block acknowledgment request frame, or both, include a special association identifier value in a per association identifier traffic identifier field, wherein the special association identifier value indicates the transmission opportunity return indication.

7. The first wireless AP of claim 1, wherein the one or more second frames comprise a management frame or a control frame.

8. The first wireless AP of claim 7, wherein the one or more second frames comprise the management frame, and wherein the management frame is a public action frame or an action frame.

9. The first wireless AP of claim 7, wherein the one or more second frames comprise the management frame, and wherein the management frame does not include a frame body field.

10. The first wireless AP of claim 1, wherein the processing system is further configured to cause the first wireless AP to:
receive, from the second wireless AP, one or more third frames that comprise feedback that indicates whether the one or more second frames were successfully received at the second wireless AP.

11. The first wireless AP of claim 1, wherein, to communicate the one or more second frames, the processing system is configured to cause the first wireless AP to:
transmit, to the second wireless AP, a frame indicating one or more subchannels of the portion of the transmission opportunity over which the first wireless AP communicated the one or more second frames.

12. The first wireless AP of claim 1, wherein, to receive the one or more first frames, the processing system is configured to cause the first wireless AP to:
receive a list that indicates a plurality of APs and an order of the plurality of APs for sharing of one or more portions of the transmission opportunity in accordance with the order.

13. The first wireless AP of claim 12, wherein, to communicate the one or more second frames, the processing system is configured to cause the first wireless AP to:
transmit, to a third wireless AP, an indication of a second allocation of a second portion of the transmission opportunity to the third wireless AP in accordance with the order.

14. The first wireless AP of claim 13, wherein, to communicate the one or more second frames, the processing system is configured to cause the first wireless AP to:
transmit, to the third wireless AP, security information associated with the transmission opportunity, the second portion of the transmission opportunity, or both.

15. The first wireless AP of claim 1, wherein the first wireless AP and the second wireless AP are in the unassociated state with respect to each other based at least in part on the first wireless AP failing to request to join a basic service set associated with the second wireless AP.

16. A method for wireless communications at a first wireless access point (AP), comprising:
receiving, from a second wireless AP, one or more first frames that indicate wireless medium coordination information associated with a transmission opportunity of a shared wireless medium obtained by the second wireless AP, the one or more first frames indicating an allocation of a portion of the transmission opportunity to the first wireless AP, wherein the first wireless AP and the second wireless AP are in an unassociated state with respect to each other; and
communicating, in accordance with the wireless medium coordination information, one or more second frames with one or more wireless devices or one or more wireless APs via the portion of the transmission opportunity.

17. The method of claim 16, wherein the wireless medium coordination information comprises an indication of a buffer status, a transmission opportunity parameter, an intention to not participate in response to receiving a polling frame, one or more APs that are disallowed from participating in the transmission opportunity, one or more spatial reuse candidate AP pairs, a coordinated beam forming request, a starting or stopping procedure for a second transmission opportunity associated with a third wireless AP, one or more network allocation vector protection settings, a dynamic bandwidth expansion indication, a coordinated target wake up time, or any combination thereof.

18. The method of claim 16, further comprising:
setting an address field of the one or more second frames to a special address for communicating coordination information between unassociated APs.

19. The method of claim 16, wherein:
the unassociated state comprises an unauthenticated state, and
the first wireless AP and the second wireless AP are in the unassociated state based at least in part on failure to exchange one or more association frames, failure to exchange one or more reassociation frames, failure to establish a security key, or any combination thereof.

20. A second wireless access point (AP), comprising:
a processing system that includes processor circuitry and memory circuitry that stores code, the processing system configured to cause the second wireless AP to:
perform a contention procedure to obtain a transmission opportunity of a shared wireless medium;
transmit, to a first wireless AP, one or more first frames that indicate wireless medium coordination information associated with the transmission opportunity of the shared wireless medium obtained by the second wireless AP, the one or more first frames indicating an allocation of a portion of the transmission opportunity to the first wireless AP, wherein the first wireless AP and the second wireless AP are in an unassociated state with respect to each other; and
receive one or more second frames from the first wireless AP in accordance with the wireless medium coordination information.

21. The second wireless AP of claim 20, wherein:
the one or more second frames comprise a transmission opportunity return indication in accordance with the wireless medium coordination information, and
the transmission opportunity return indication indicates that a remainder of the transmission opportunity is being returned.

22. The second wireless AP of claim 21, wherein the transmission opportunity return indication is within a field of a header of the one or more second frames.

23. The second wireless AP of claim 20, wherein the one or more second frames indicate that a remainder of the transmission opportunity is being returned.

24. The second wireless AP of claim 20, wherein, to receive the one or more second frames, the processing system is configured to cause the second wireless AP to:
receive, from the first wireless AP, one or more of a clear to send indication, a block acknowledgment frame, a block acknowledgment request frame, or any combination thereof, to indicate a transmission opportunity return indication to indicate that a remainder of the transmission opportunity is being returned.

25. The second wireless AP of claim 20, wherein the one or more second frames comprise a management frame or a control frame.

26. A method for wireless communications at a second wireless access point (AP), comprising:
performing a contention procedure to obtain a transmission opportunity of a shared wireless medium;
transmitting, to a first wireless AP, one or more first frames that indicate wireless medium coordination information associated with the transmission opportunity of the shared wireless medium obtained by the second wireless AP, the one or more first frames indicating an allocation of a portion of the transmission opportunity to the first wireless AP, wherein the first wireless AP and the second wireless AP are in an unassociated state with respect to each other; and
receiving one or more second frames from the first wireless AP in accordance with the wireless medium coordination information.

27. The method of claim 26, further comprising:
transmitting, to the first wireless AP, one or more third frames that comprise feedback that indicates whether the one or more second frames were successfully received at the second wireless AP.

28. The method of claim 26, wherein receiving the one or more second frames comprises:
receiving, from the first wireless AP, a frame indicating one or more subchannels of the portion of the transmission opportunity over which the first wireless AP communicated one or more third frames.

29. The method of claim 26, wherein transmitting the one or more first frames comprises:
transmitting a list that indicates a plurality of wireless APs and an order of the plurality of wireless APs for sharing of one or more portions of the transmission opportunity in accordance with the order.

30. The method of claim 26, further comprising:
transmitting, to the first wireless AP, an indication of a capability, an operational mode, or both, of the second wireless AP to allow sharing of the transmission opportunity.
